(19) United States
(12) Patent Application Publication
(10) Pub. No.: US 2026/0351993 A1
(43) Pub. Date: Nov. 5, 2026

(54) MULTI-BATTERY PROVIDED IN DEVICE AND METHOD FOR CONTROLLING MULTI-BATTERY

(71) Applicant: Bear Robotics Korea, Inc., Seoul (KR)

(72) Inventor: Byungyoon Choi, Seoul (KR)

(21) Appl. No.: 19/488,568

(22) PCT Filed: Jun. 1, 2023
(86) PCT No.: PCT/KR2023/007544

§ 371 Date: Nov. 26, 2025

(51) Int. Cl. H02J 7/46; H01M 10/42; H01M 10/44; H01M 10/48; H02J 7/54

(52) U.S. Cl. CPC H02J 7/46; H01M 10/4207; H01M 10/425; H01M 10/441; H01M 10/443; H01M 10/482; H01M 10/486; H02J 7/54; H01M 2010/4271

(57) ABSTRACT

The present invention relates to a multi-battery comprising a plurality of battery packs, wherein each of the plurality of battery packs includes at least one battery cell and a battery management system (BMS). When a power-on signal is received, any one BMS set as a master among the plurality of battery packs detects a battery pack that is not turned on among the other battery packs set as slaves. When a slave battery pack that is not turned on is detected, the BMS set as a master transmits a signal, preset so as to turn on the detected slave battery pack, to the BMS of the detected slave battery pack to turn on the detected slave battery pack, and indicates that the plurality of battery packs are turned on, only when all the slave battery packs and the master battery pack are turned on.

### TECHNICAL FIELD

The present disclosure relates to a multi-battery including a plurality of battery packs and a method of controlling the multi-battery.

### BACKGROUND

With the advancement of current technology, various devices having diverse functions have been developed. In addition, with the development of battery-related technologies, such devices can be equipped with large-capacity batteries and receive power required for operation through the installed batteries. This allows them to overcome the limitations of wired power supply, thereby greatly enhancing the mobility and usability of such devices. As battery technology has advanced, and as the mobility of devices has improved, devices capable of recognizing the environments using their own capabilities and automatically performing or operating assigned tasks according to the recognized environments, so-called robots, have been introduced.

As related technologies have continued to develop, robots are now capable of providing a wide variety of useful services. However, as the functionality of robots becomes more advanced, the amount of driving power consumed by the robots increases accordingly. As the driving power to the robots is supplied from a battery, there is a demand for batteries capable of storing a larger amount of power and supplying such power in a stable manner.

In response to this social demand, auxiliary batteries that can be installed together with existing batteries have been developed. The additional power supplied by such auxiliary batteries enables the operating time of devices to be extended. However, since auxiliary batteries are additionally provided to the existing devices, they must be manually charged by the user separately from the devices, which causes inconvenience. Furthermore, as they are separate from the batteries installed in the devices and supply power through independent connection ports, power loss and circuit damage may occur depending on the quality of the power supplied from the auxiliary batteries.

As an alternative to such auxiliary batteries, a configuration has been proposed in which a device includes a plurality of batteries, that is, a plurality of battery packs. In this case, when the device is charged, all the battery packs may be charged simultaneously. Also, when the device is operated, electricity may be discharged from the battery packs simultaneously, thereby greatly increasing the operating time of the device. Moreover, since the plurality of battery packs is composed of homogeneous batteries, power loss or deterioration of the quality of supplied power, which may be caused by use of heterogeneous batteries, may be avoided.

However, during operation of a device equipped with a plurality of battery packs, some of the battery packs may be switched to a protection mode due to the temperature of the battery packs or abnormal operational conditions. Battery packs switched to the protection mode may be restricted from charging or discharging. In such a case, charging and discharging may occur in the other battery packs that have not switched to the protection mode. Consequently, the current that should have been evenly supplied to or discharged from the entire battery packs may instead be discharged from or supplied to the other battery packs, thereby causing overcharging or over-discharging of the remaining battery packs.

Furthermore, when charging or discharging of some battery packs is restricted due to the protection mode or battery replacement, a voltage difference may occur between the battery packs that have been switched to the protection mode or have been replaced and the other battery packs. Such a voltage difference may induce internal charge and discharge of current supplied from a battery pack having a higher voltage to a battery pack having a lower voltage. This internal charge and discharge may cause damage to the internal circuits of the battery packs.

Accordingly, for devices including a plurality of battery packs, that is, a multi-battery, there is a need for a technique capable of preventing voltage imbalance among the battery packs and maintaining voltage balance therebetween, and active research is currently being conducted in this field.

### DISCLOSURE

### Technical Problem

The present disclosure is directed to solving the above-described issues and other related issues, and an object of the present disclosure is to provide a multi-battery capable of maintaining voltage balance among a plurality of provided battery packs when some of the battery packs are switched to a protection mode, and a method of controlling the multi-battery.

Another object of the present disclosure is to provide a multi-battery capable of maintaining voltage balance among a plurality of battery packs provided in a device, even when some of the battery packs are not powered on or powered off during the power-on or power-off operation of the device, and a method of controlling the multi-battery.

### Technical Solution

In one aspect of the present disclosure, a multi-battery may include a plurality of battery packs, each including at least one battery cell and a Battery Managing System (BMS) configured to manage the at least one battery cell. Based on that a power-on signal for turning on power is received, the BMS of a battery pack set as a master among the plurality of battery packs may detect a battery pack not powered on among at least one other battery pack set as a slave. Based on that the slave battery pack not powered on is detected, the master BMS transmits may transmit a preset power-on signal to the BMS of the detected slave battery pack to power on the detected slave battery pack. The plurality of battery packs may be indicated to be powered on only when the slave battery pack and the master battery pack are all powered on.

In one embodiment, based on that a power-off signal for turning off the power is received, the BMS of the master battery pack may detect a battery pack not powered off among the at least one slave battery pack. Based on that the slave battery pack not powered off is detected, the BMS of the master battery pack may transmit a preset power-off signal to the BMS of the detected slave battery pack to power off the detected slave battery pack, and may power off the master battery pack after the slave battery pack is all powered off. In one embodiment, the BMS of the master battery pack may detect an operation state of each of the plurality of battery packs including the master battery pack and the at least one slave battery pack, and control the BMS of at least one of the plurality of battery packs according to the detected operation state to change a charging amount or discharging amount of the at least one battery pack to keep voltages of the plurality of battery packs equal.

In one embodiment, based on that at least one of the plurality of battery packs is switched to a protection mode causing charging or discharging to be stopped, the BMS of the master battery pack may control the BMS of at least one other battery pack not switched to the protection mode to restrict the charging or discharging of the at least one other battery pack.

In one embodiment, based on whether the at least one battery pack switched to the protection mode has been switched to a normal mode, the BMS of the master battery pack may release the restriction on the charging or discharging of the at least one other battery pack to allow all the plurality of packs to perform the charging or discharging simultaneously.

In one embodiment, based on the master battery pack being switched to the protection mode, one of the at least one slave battery pack is switched to a master battery pack, and the master battery pack switched to the protection mode is switched to a slave battery pack.

In one embodiment, based on that the plurality of battery packs is discharging, the BMS of the master battery pack may detect the voltage of each of the plurality of battery packs, and detects a first battery pack having a higher voltage than the at least one other battery pack. The BMS may restrict discharging of the at least one other battery pack except the first battery pack to allow only the first battery pack to perform the discharging until the voltage of the first battery pack reaches the voltage of the at least one other battery pack.

In one embodiment, based on that the plurality of battery packs is being charged, the BMS of the master battery pack may detect the voltage of each of the plurality of battery packs, and detect a second battery pack having a lower voltage than the at least one other battery pack, and restrict charging of the other battery packs except for the second battery pack until the voltage of the second battery pack reaches the voltage of the at least one other battery pack.

In one embodiment, the BMS of the master battery pack may detect a temperature of each of the plurality of battery packs, detect a high-temperature battery pack having a higher temperature than the at least one other battery pack or a low-temperature battery pack having a lower temperature than the at least one other battery pack, and control, based on a difference between the temperature of the high-temperature battery pack or the low-temperature battery pack and the temperature of the at least one other battery pack, the BMS of the high-temperature battery pack to reduce charging current or discharging current or control the BMS of the low-temperature battery pack to increase the charging current or discharging current.

In one embodiment, each of the battery packs may further include a plurality of battery cells, a first charging path allowing charging current supplied from a device equipped with the multi-battery to flow therethrough, a second charging path connected in parallel with the plurality of battery cells and arranged to supply the charging current from the first charging path to the plurality of battery cells, a charging Field Effect Transistor (FET) disposed between the first charging path and the second charging path and configured to connect or disconnect the first charging path and the second charging path depending on an applied charging gate driving voltage, a second discharging path connected in parallel with the plurality of battery cells and allowing discharging current discharged from the plurality of battery cells to flow therethrough, a first discharging path arranged to supply the discharging current from the second discharging path to the device equipped with the multi-battery, a discharging FET disposed between the first discharging path and the second discharging path and configured to connect or disconnect the first discharging path and the second discharging path depending on an applied discharging gate driving voltage, and a BMS configured to apply the charging gate driving voltage and the discharging gate driving voltage to the charging FET and the discharging FET.

In one embodiment, based on the charging gate driving voltage and the discharging gate driving voltage being greater than or equal to a preset threshold voltage, the charging FET and the discharging FET may vary an amount of current allowed to flow between the first charging path and the second charging path or between the first and second discharging paths according to magnitudes of the voltages. The BMS may control the charging gate driving voltage and the discharging gate driving voltage applied to the charging FET and the discharging FET to control the charging amount or discharging amount of the battery packs.

In one embodiment, the multi-battery may further include at least one variable resistor having a resistance varying according to a control by the BMS, the at least one variable resistor being disposed between at least one of the first charging path or the second charging path and the charging FET, and between at least one of the first discharging path or the second discharging path and the discharging FET. The BMS may control the at least one variable resistor to limit the amount of current between the first charging path and the second charging path or between the first discharging path and the second discharging path to vary the charging amount or discharging amount of the battery packs.

In another aspect of the present disclosure, a method of controlling the multi-battery according to an embodiment may include controlling, by the BMS of a battery pack set as a master among the plurality of battery packs, the plurality of battery packs including the master battery pack and at least one other battery pack set as a slave according to a power-on signal to cause all the battery packs to perform charging or discharging simultaneously, collecting, by the BMS of the master battery pack, operation state related information including a temperature, a voltage, and a state of switching to a protection mode of the plurality of battery packs, detecting, by the BMS of the master battery pack, some battery packs switched to the protection mode among the plurality of battery packs based on the collected operation state related information, restricting, by the BMS of the master battery pack, the charging or discharging of the other battery packs except for the battery packs switched to the protection mode, checking, by the BMS of the master battery pack, whether the some battery packs switched to the protection mode have been switched to a normal mode, and releasing, by the BMS of the master battery pack, the charging or discharging of the other battery packs according to a result of the checking and controlling the plurality of battery packs to cause all the other battery packs and the some battery packs switched to the normal mode to perform the charging or discharging simultaneously.

In one embodiment, the collecting of the operation state related information may include detecting, by the BMS of the master battery pack, the voltage of each of the plurality of battery packs, detecting, by the BMS of the master battery pack, a first battery pack having a higher voltage than at least one other battery pack or a second battery pack having a lower voltage than the at least one other battery pack, and, based on whether the plurality of battery packs is performing the discharging or charging, restricting, by the BMS of the master battery pack, the discharging of the at least one other battery pack except for the first battery pack to allow the first battery pack to perform the discharging, or restricting the charging of the at least one other battery pack except for the first battery pack to allow the first battery pack to perform the charging.

In another aspect of the present disclosure, a robot equipped with the multi-battery according to an embodiment may include a battery unit having the multi-battery, a switch configured to receive an input signal for powering on or off the battery unit, an indicator configured to indicate a power-on or power-off state of the battery unit according to the input signal, and a controller configured to transmit, based on that the power-on signal being input through the switch while the battery unit is powered off, the power-on signal to each of the battery packs of the battery unit to power on each of the battery packs of the battery unit, and control, based on that the slave pack and the master battery pack are all powered on, the indicator to indicate the power-on state of the plurality of battery packs.

In one embodiment, based on that the master battery pack is not powered on by the transmission of the power-on signal, the controller may switch one of the at least one slave battery pack to a master battery pack and switches the master battery pack not powered on to a slave battery pack. The BMS of the battery pack switched to the master according to the control by the controller may detect power of at least one slave battery pack not powered on by the power-on signal, and turn on the power of the detected slave battery pack.

In one embodiment, the controller may transmit, based on that the power-off signal is input through the switch while the battery unit is powered on, the power-off signal to each of the battery packs of the battery unit to power off each of the battery packs of the battery unit, and control, based on that the slave battery pack and the master battery pack are all powered off, the indicator to indicate that the plurality of battery packs is powered off.

In one embodiment, based on that at least one battery pack among the plurality of battery packs exceeds a preset operating temperature range, the controller may switch the at least one battery pack exceeding the operating temperature range to a protection mode. The controller may control the BMS of at least one other battery pack not switched to the protection mode to restrict charging or discharging of the at least one other battery pack not switched to the protection mode. The controller may release the restriction on the charging or discharging of the at least one other battery pack based on whether the at least one battery pack switched to the protection mode has been switched to a normal mode to control the battery unit to cause all the plurality of battery packs to perform the charging or discharging simultaneously.

In one embodiment, based on that the plurality of battery packs is discharging, the controller may detect a voltage of each of the plurality of battery packs, and detect a first battery pack having a lowest voltage. The controller may restrict the discharging of the first battery pack until the voltages of the other battery packs except for the first battery pack reach the voltage of the first battery pack.

In one embodiment, based on that the plurality of battery packs is being charged, the controller may detect a voltage of each of the plurality of battery packs, and detect a second battery pack having a highest voltage. The controller may restrict charging of the second battery pack until the voltages of the other battery packs except for the second battery pack reach the voltage of the second battery pack.

### Advantageous Effects

A multi-battery and a method of controlling the multi-battery according to the present disclosure may have the following effects.

According to at least one embodiment of the present disclosure, when at least one of a plurality of battery packs is switched to a protection mode, the charging or discharging of the other battery packs is restricted until the protection mode is released. Accordingly, voltage imbalance among the battery packs may be prevented.

According to at least one embodiment of the present disclosure, when the power to a device is turned on or off, a Battery Management System (BMS) of a master battery pack among the plurality of battery packs detects the power-on or power-off state of at least one other battery pack (slave battery pack), and power on or off the at least one other battery pack that is not powered on or off. As a result, all the battery packs may be simultaneously powered on or off. Thereby, voltage imbalance among the battery packs may be prevented.

According to at least one embodiment of the present disclosure, when a voltage imbalance occurs among the plurality of battery packs due to temperature or other environmental conditions, the charging current or discharging current may be adjusted differently for a battery pack having a lower voltage and a battery pack having a higher voltage, thereby preventing voltage imbalance among the plurality of battery packs.

### BRIEF DESCRIPTION OF THE DRAWINGS

FIG. 1A is a block diagram illustrating a configuration of a robot equipped with a plurality of battery packs and a charging station according to an embodiment of the present disclosure.

FIG. 1B is a block diagram illustrating in more detail the configuration of the robot according to the embodiment of the present disclosure.

FIG. 2 is a block diagram illustrating in more detail the configuration of a battery pack provided in the robot according to an embodiment of the present disclosure.

FIG. 3 is a flowchart illustrating an operation procedure in which a plurality of battery packs provided in the robot is controlled according to an embodiment of the present disclosure.

FIGS. 4 and 5 are exemplary diagrams illustrating examples in which, when one battery pack is switched to a protection mode, the other battery packs are controlled according to an embodiment of the present disclosure.

FIGS. 6 and 7 are flowcharts illustrating operation procedures in which a charging current or a discharging current is restricted according to the temperature of battery packs during charging or discharging in the robot according to an embodiment of the present disclosure.

FIG. 8 is a flowchart illustrating an operation procedure in which charging or discharging is restricted according to voltage differences among the battery packs in the robot according to an embodiment of the present disclosure.

FIG. 9 is an exemplary diagram illustrating an example in which switching to a master battery pack is performed according to switching to a protection mode in the robot according to an embodiment of the present disclosure.

FIGS. 10A and 10B are flowcharts illustrating operation procedures in which power-off or power-on of each battery pack is managed according to a power-off or power-on signal in the robot according to an embodiment of the present disclosure.

FIG. 11 is an exemplary diagram illustrating an example of a power key provided on a body of the robot to receive a power-on or power-off signal from a user according to an embodiment of the present disclosure.

FIG. 12 is a flowchart illustrating an operation procedure in which master switching is performed when the master battery pack is not powered on in FIG. 10B, according to an embodiment of the present disclosure.

### DETAILED DESCRIPTION

It should be noted that the technical terms used in the present specification are employed merely to describe particular embodiments, and are not intended to limit the scope of the present disclosure. In addition, the singular forms used in the present specification are intended to include plural forms, unless the context clearly indicates otherwise. The suffixes “module” and “unit” used for components in the following description are provided merely for convenience in drafting the specification and may be used interchangeably, without implying any distinction in meaning or function.

In the present specification, terms such as “comprise” or “include” should not be construed as meaning that all components or steps described in the specification must be included. Rather, such terms should be interpreted as meaning that some components or steps may not be included, or that additional components or steps may be further included.

In describing the technology disclosed in the present specification, detailed descriptions of well-known technologies may be omitted to avoid obscuring the gist of the technology disclosed in the present specification.

The accompanying drawings are provided merely to facilitate understanding of the embodiments disclosed herein. The technical idea disclosed in this specification should not be limited by the drawings. It should be understood that all modifications, equivalents, and substitutions that fall within the spirit and scope of the present disclosure are encompassed by the present disclosure. In addition, not only each embodiment described below but also combinations of the embodiments are regarded as modifications, equivalents, or substitutions included within the spirit and scope of the present disclosure.

For simplicity, in the following description, a device equipped with a plurality of battery packs, i.e., a multi-battery according to embodiments of the present disclosure is assumed to be a robot, such as a robot cleaner or an autonomous driving robot. However, it should be noted that the present disclosure is not limited thereto. That is, the present disclosure can be applied not only to robots but also various devices that include a battery and can be supplied with electric power from the battery.

In the following description, a plurality of battery packs provided according to embodiments of the present disclosure may each include a separate Battery Management System (BMS). Each BMS may be connected to a plurality of battery cells and may be configured to manage charging and discharging of the battery cells connected thereto. Among the plurality of battery packs, one battery pack may be set as a master, and the other battery packs different from the master battery pack may be set as slaves. The BMS of the battery pack set as the master, i.e., the master BMS, may be configured to manage not only the plurality of cells connected thereto but also the BMSs of the battery packs set as slaves, i.e., the slave BMSs.

The operation procedure for voltage balance among the battery packs described below may be performed by a controller of a device, for example, a robot according to an embodiment of the present disclosure, or may alternatively be performed by the master BMS of the battery pack set as the master. Accordingly, even when the entity performing the operation procedure is not explicitly mentioned, or only one of the controller of the robot or the master BMS is mentioned as an entity of an operation procedure in the following description, it should be understood that the master BMS or the controller of the robot that is not mentioned can perform the same or similar operation procedure.

For simplicity, in the following description, it is assumed that the operation procedure for voltage balance among the battery packs is performed by the master BMS. In addition, in the following description, the device including the multi-battery, i.e., a battery unit including a plurality of battery packs, is assumed to be a robot. However, it should be noted that this assumption is made solely for simplicity, and the device equipped with the multi-battery according to embodiments of the present disclosure is not limited to the robot.

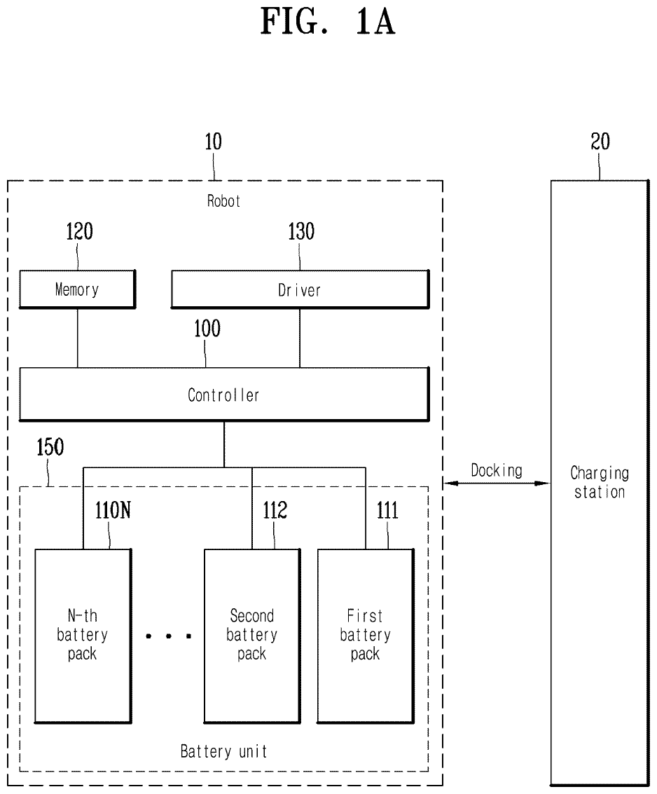

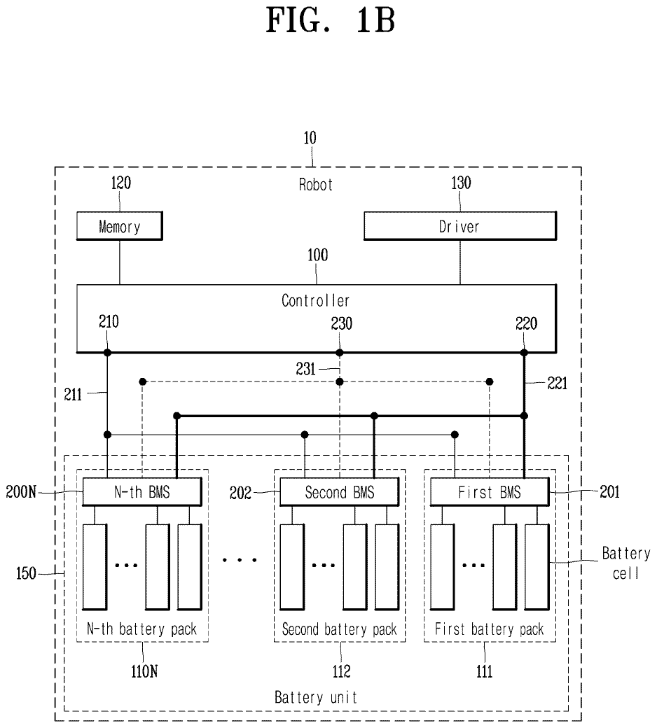

FIG. 1A is a block diagram illustrating a configuration of a robot equipped with a plurality of battery packs and a charging station according to an embodiment of the present disclosure.

Referring to FIG. 1A, a robot 10 according to an embodiment of the present disclosure may include a controller 100, a memory 120 connected to the controller 100, a driver 130, and a battery unit 150 including a plurality of battery packs.

The driver 130 may include at least one component configured to provide various services which can be provided by the robot 10 according to the purpose of the robot 10.

For example, when the robot 10 is a robot cleaner, the driver 130 may include a moving unit for movement of the robot 10, at least one sensor, and a suction unit and a filter for cleaning operation of the robot 10. When the robot 10 is a delivery robot for delivering goods, the driver 130 may include a moving unit for movement of the robot 10, at least one sensor, a support for fixing and supporting delivered goods, and a manipulator. That is, the driver 130 may include at least one different component having a mechanism (e.g., a motor or an actuator) that is driven according to the intended use of the robot 10.

The at least one component included in the driver 130 may be driven according to the operation power applied thereto. In this case, the driving mechanism may generate a predetermined amount of heat while being driven by the operation power. Accordingly, heat generated according to the operation of the driver 130 may be dissipated to the area surrounding the robot 10 having the driver 130.

The battery unit 150 may provide current for driving the driver 130 and other components of the robot 10, i.e., the controller 100 and the memory 120. To this end, the battery unit 150 may include a plurality of battery packs 111, 112, . . . , 110N connected in parallel. The current discharged from the plurality of battery packs 111, 112, . . . , 110N may be supplied to the controller 100, and the current supplied from the battery unit 150 under control of the controller 100 may be provided to each component, for example, the driver 130 and the memory 120.

Here, each of the plurality of battery packs 111, 112, . . . , 110N may include a plurality of cells and a BMS configured to manage the plurality of cells. Among the plurality of battery packs 111, 112, . . . , 110N, one battery pack may be set as a master, and at least one other battery pack may be set as a slave. In this case, the BMS of the battery pack set as the master (hereinafter referred to as a master BMS) may perform control to maintain and manage not only itself but also the BMS of the battery pack set as the slave (hereinafter referred to as a slave BMS).

Hereinafter, the configuration of the robot 10 equipped with the battery unit 150 including the plurality of battery packs 111, 112, . . . , 110N will be described in more detail with reference to FIG. 1B.

The memory 120 may store data supporting various functions of the robot 10. The memory 120 may store multiple application programs (or applications) running on the robot 10, as well as data and instructions for operating the robot 10. The application programs may be stored in the memory 120, installed on the robot 10, and executed by the controller 100 to perform operations (or functions) of the robot 10.

The controller 100 may control each connected component and may control the overall operations of the robot 10. The controller 100 may control at least one component included in the driver 130 to provide services according to a specified purpose, and may store data processed through the driver 130 in the memory 120 or control at least one component connected to the controller 100 according to an application program stored in the memory 120.

The controller 100 may supply the driving current received from the battery unit 150 to the driver 130 and the memory 120 for operations of the driver 130 and the memory 120. Alternatively, when the robot 10 is docked to a charging station 20 connected to a commercial power source (not shown), the current supplied through the charging station 20 may be supplied to the battery unit 150 to charge each of the plurality of battery packs 111, 112, . . . , 110N included in the battery unit 150.

In this case, the controller 100 may supply the same charging current to all the battery packs 111, 112, . . . , 110N to charge all the battery packs 111, 112, . . . , 110N simultaneously. Alternatively, the controller 100 may control the amount of charging current with which each battery pack is charged or stop supplying the charging current according to the condition of each of the battery packs 111, 112, . . . , 110N.

FIG. 1B is a block diagram illustrating in more detail the configuration of the robot 10 according to the embodiment of the present disclosure.

Referring to FIG. 1B, each of the battery packs 111, 112, . . . , 110N according to the embodiment of the present disclosure may include a plurality of battery cells and a BMS 201, 202, . . . , 200N configured to manage the plurality of battery cells.

The battery cells in a battery pack may be connected to each other in series. The BMS of each battery pack may perform control to manage the battery cells. For example, when charge imbalance occurs among the battery cells, the BMS may remove charge from one battery cell with a higher voltage through heat dissipation, thereby equalizing the charging amount among the cells.

Each BMS 201, 202, . . . , 200N may include a charging port and a discharging port. The charging ports and discharging ports of the BMSs 201, 202, . . . , 200N may be connected to the charging port 210 and the discharging port 220 of the controller 100. Hereinafter, the electrical path connecting the charging port 210 of the controller 100 and the charging port of each BMS 201, 202, . . . , 200N may be referred to as a charging path 211, and the electrical path connecting the discharging port 220 of the controller 100 and the discharging port of each BMS 201, 202, . . . , 200N may be referred to as a discharging path 221.

In this case, as the battery unit 150 includes a plurality of battery packs 111, 112, . . . , 110N as described above, the charging port 210 of the controller 100 may be connected to the charging ports of the respective battery packs in parallel by the charging paths 211. Similarly, the discharging port 220 of the controller 100 may be connected to the discharging ports of the respective battery packs in parallel by the discharging paths 221. Accordingly, the charging current supplied through the charging port 210 of the controller 100 may be equally supplied to the charging ports of the plurality of battery packs, and the discharging current discharged simultaneously from the plurality of battery packs may be supplied to the discharging port 220. That is, the plurality of battery packs 111, 112, . . . , 110N may charge or discharge simultaneously through the charging paths 211 and discharging paths 221.

The controller 100 may be communicatively connected to the BMSs 201, 202, . . . , 200N of the battery packs using a preset communication scheme. For example, the preset communication scheme may be CAN (Controller Area Network) communication, which is a message-based network protocol in a non-host bus configuration.

The communication port 230 of the controller 100 may be connected to a communication path 231 connected to the communication ports 231 of the respective BMSs 201, 202, . . . , 200N, similar to the charging port 210 and discharging port 220. Through the communication path 231, the controller 100 may be connected in parallel to the BMSs 201, 202, . . . , 200N to collect state information about the BMSs 201, 202, . . . , 200N of the respective battery packs. Based on the collected state information, the controller may control at least some of the BMSs 201, 202, . . . , 200N to control charging or discharging of at least some of the plurality of battery packs 111, 112, . . . , 110N.

Alternatively, the communication path 231 may be used for communication among the BMSs 201, 202, . . . , 200N of the battery packs. For example, the master BMS may be communicatively connected to a specific slave BMS through the communication path 231. In this case, the master BMS may broadcast a message intended for the specific slave BMS through the communication path 231, and the specific slave BMS may receive the message through the communication path 231. Thereby, communication may be established between the master BMS and the slave BMS. In other words, through the communication path 231, the master BMS may control at least one slave BMS, thereby controlling charging or discharging of not only the battery pack it manages but also at least one other battery pack.

Conversely, a specific slave BMS may also broadcast a message intended for the master BMS through the communication path 231. Thereby, the master BMS may request information related to the state of the specific slave BMS, collect the state information related to the specific slave BMS in response, and control operations of the specific slave BMS, such as charging or discharging, based on the collected information.

The charging current supplied through the charging path 211 or the discharging current may be controlled by field effect transistors (FETs) controlled by the BMS 200.

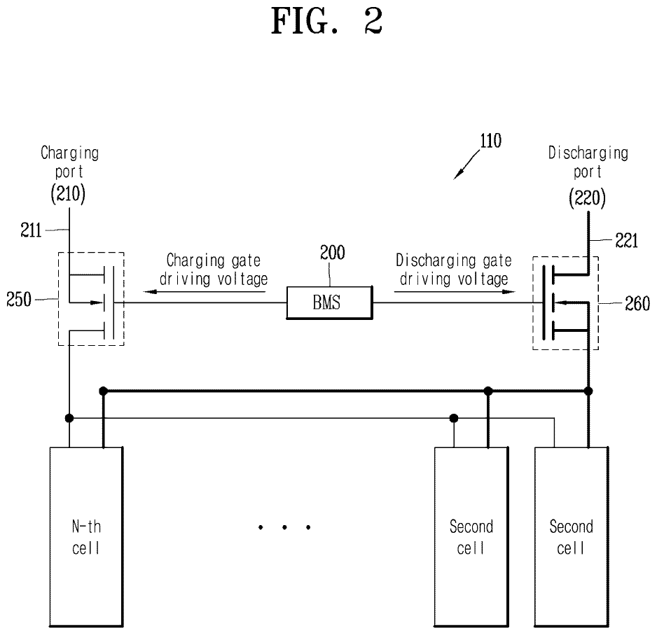

FIG. 2 is a block diagram illustrating in more detail the internal configuration of a battery pack 200 including FETs configured to control the charging current of the battery pack 200 or the discharging current discharged from the battery pack 200.

Referring to FIG. 2, an FET 250 may be provided between the charging path 211 and the plurality of battery cells included in the battery pack 110. The FET 250 may be a device in which the current flowing between two terminals (i.e., Source and Drain) is controlled based on an input voltage applied to the gate terminal.

In this case, the source terminal of the FET 250 may be connected to the charging port 210 (or the charging path 211), and the drain terminal of the FET 250 may be connected in parallel with the battery cells in the battery pack 110. The gate terminal of the FET 250 may be connected to the BMS 200 to receive a voltage input from the BMS 200.

Accordingly, the BMS 200 may apply a voltage to the gate terminal of the FET 250 to allow current to flow between the source terminal and drain terminal or block current from flowing between the source terminal and drain terminal. For example, when the input voltage applied to the gate terminal is less than a preset threshold voltage, current may not flow between the source terminal and the drain terminal (hereinafter, this state is referred to as FET off). On the other hand, when the input voltage applied to the gate terminal is greater than or equal to the preset threshold voltage, current may flow between the source and drain terminals (hereinafter, this state is referred to as FET on).

As described above, the FET may also control the maximum current flowing between the source and drain terminals based on the input voltage applied to the gate terminal. For example, when the voltage applied to the gate terminal by the BMS 200 increases, the maximum current flowing between the source and drain terminals may increase. Accordingly, the BMS 200 may adjust the amount of charging current supplied to each battery cell of the battery pack 110 by adjusting the gate terminal driving voltage (hereinafter referred to as the charging gate driving voltage).

Thus, when the FET is turned on according to the charging gate driving voltage, the charging current supplied through the charging path 211 may be supplied to the plurality of cells via the source and drain terminals. Hereinafter, the FET 250 is referred to as an FET supplying charging current, namely a charging FET.

Similarly to the charging FET 250, a discharging FET 260 may be provided between the plurality of battery cells and the discharging port 220. Depending on the current flow, the source terminal of the discharging FET 260 may be connected in parallel to the plurality of battery cells, and the drain terminal of the discharging FET 260 may be connected to the discharging path 221 connected to the discharging port 220.

The BMS 200 may apply a voltage to the gate terminal of the discharging FET 260 to allow current to flow between the source terminal and drain terminal, or block current from flowing between the source terminal and drain terminal. Furthermore, the maximum current flowing between the source and drain terminals may be controlled based on the input voltage applied to the gate terminal. Accordingly, the BMS 200 may control the amount of discharging current discharged from the battery pack 110 by adjusting the gate driving voltage applied to the discharging FET 260 (hereinafter referred to as the discharging gate driving voltage).

The BMS 200 may adjust the charging gate driving voltage or discharging gate driving voltage according to control by another BMS, for example, the master BMS, or the controller 100. Accordingly, the master BMS or the controller 100 may control the amount of charging current supplied to at least one battery pack or the amount of discharging current discharged from the at least one battery pack.

Alternatively, the master BMS or the controller 100 may adjust the charging gate driving voltage or discharging gate driving voltage to be less than a threshold voltage, thereby switching the charging FET 250 or the discharging FET 260 of the at least one battery pack to an off state. As a result, the supply of charging current to the at least one battery pack or the discharging of current from the at least one battery pack may be stopped.

A description has been given above of the configuration for controlling the amount of charging or discharging current by adjusting the gate driving voltage of the charging FET 250 or the discharging FET 260. However, the amount of charging current or discharging current controlled according to the gate driving voltage may be insufficient to meet voltage balance between battery packs.

Accordingly, the robot 10 according to the embodiment of the present disclosure may use an additional method, in addition to adjusting the gate driving voltage, to control the charging current supplied to at least some of the battery packs or the discharging current discharged from at least some of the battery packs.

For example, when the battery unit 150 starts charging, the controller 100 may collect operation states of the respective battery packs through the communication path 231. Based on the collected operation states, charging current may be supplied only to battery packs with a lower voltage (which means controlling charging FET off for battery packs with a higher voltage). Alternatively, when current is supplied from the battery unit 150 (during discharging), the controller 100 may collect the operation states of the respective battery packs through the communication path 231 and allow current to be discharged only from battery packs with a higher voltage (which means controlling discharging FET off for battery packs with a lower voltage).

In an embodiment, at least one variable resistor, whose resistance varies under control of the BMS 200, may be provided between the source terminal of each charging FET 250 and discharging FET 260 and the charging path 211, and between the drain terminal and at least one of the plurality of battery cells connected in parallel. In this case, the BNS 200 may control the resistance of the variable resistor to limit the amount of charging current supplied to each battery cell or the amount of discharging current discharged from each battery cell. For example, as the resistance of the variable resistor increases, the amount of charging or discharging current may increase. As the resistance decreases, the amount of charging or discharging current may decrease.

When the charging current of a specific battery pack (e.g., a battery pack from which a higher voltage is detected) is limited, the amount of charging current supplied to other battery packs may increase as much as the limited amount of charging current. That is, the amount of charging current supplied to the specific battery pack may be limited to be less than the amount of current supplied to the other battery packs. Similarly, when the amount of current discharged from a specific battery pack (e.g., a battery pack from which a lower voltage is detected) is limited, the amount of current discharged from other battery packs may increase as much as the limited amount of discharging current. That is, the amount of discharging current discharged from the specific battery pack may be limited to be less than the amount of current discharged from the other battery packs.

Hereinafter, with reference to multiple operation flowcharts, a description will be given in detail of the operation procedure of limiting charging or discharging of each battery pack for voltage balance among the battery packs in the robot 10 including battery packs having the above configuration according to the embodiment.

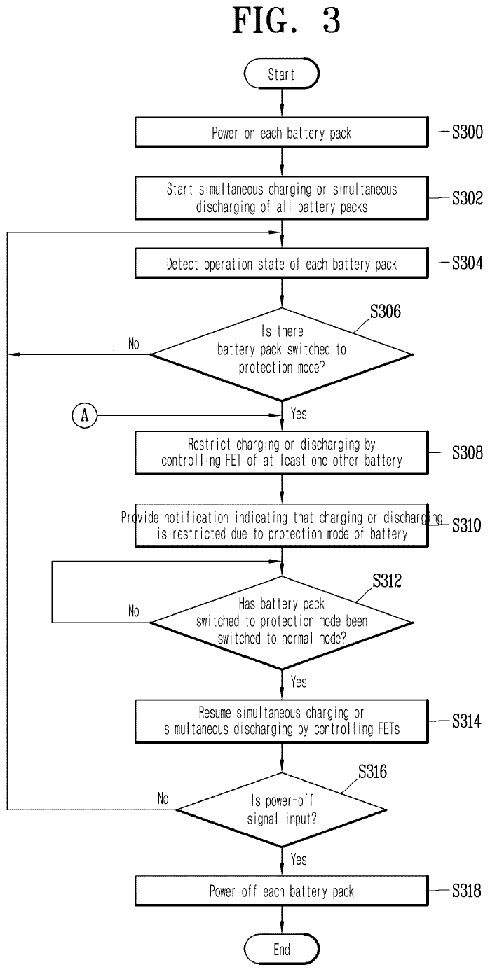

As described above, the BMS of the battery pack set as the master (hereinafter referred to as the master BMS) among the plurality of battery packs included in the battery unit 150 of the robot 10 according to the present embodiment may control the master battery pack and at least one other battery pack (slave battery pack) for voltage balance, as shown in FIG. 3.

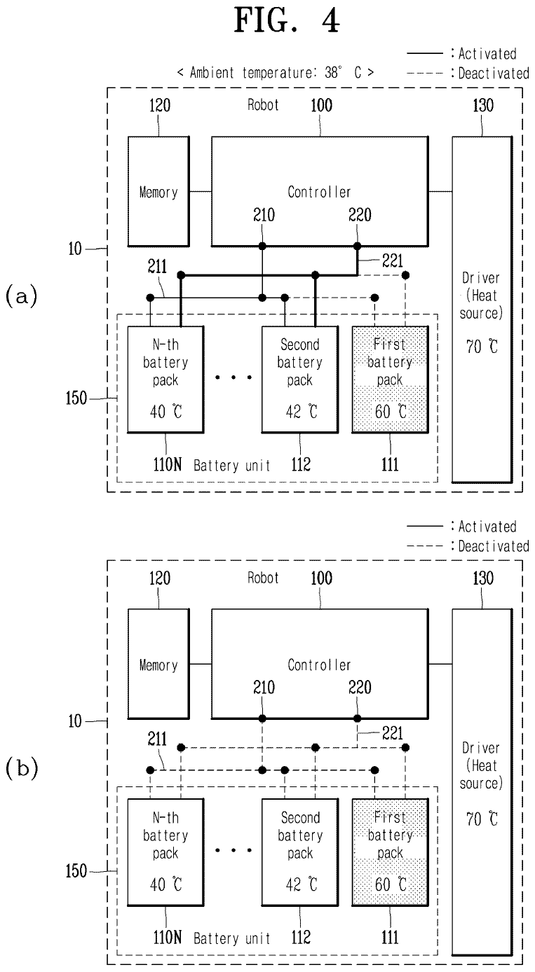

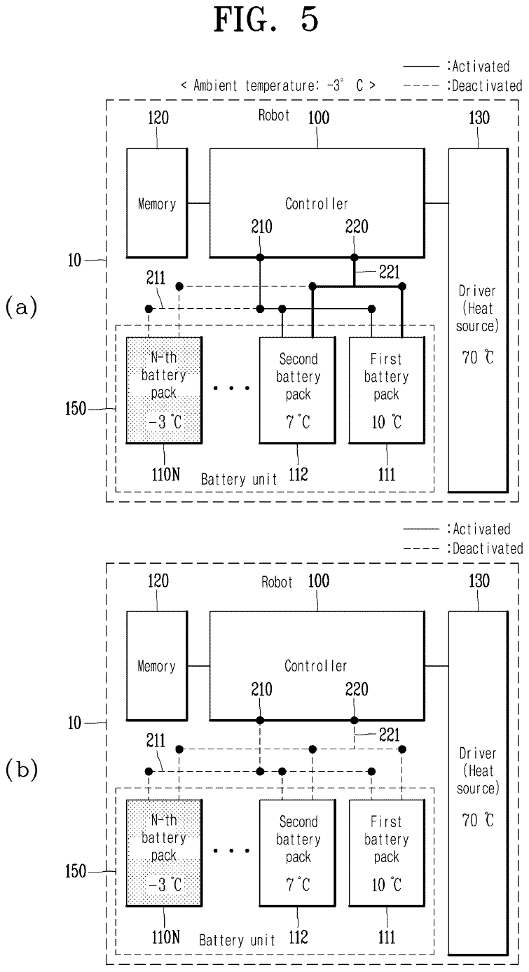

FIG. 3 is a flowchart illustrating an operation procedure in which a plurality of battery packs provided in the robot 10 is controlled according to an embodiment of the present disclosure. FIGS. 4 and 5 are exemplary diagrams illustrating examples of how other battery packs are controlled when one of the battery packs is switched to a protection mode according to an embodiment of the present disclosure.

First, referring to FIG. 3, when a power-on signal is applied by a user, the master BMS may power on each battery pack (S300). The power-on signal may be input through a predetermined key (e.g., a power key) provided on the body of the robot 10, or through a predetermined power key configured on a remote controller (not shown) configured to control the robot 10. In this case, the remote controller may be the mobile terminal of the user.

Here, in operation S300, the master BMS may check whether all the battery packs are in a power-on state. In this case, the power-on state of the battery packs may indicate that the BMS of each battery pack has been switched to an operable state, i.e., an active mode or standby mode (hereinafter referred to as the standby mode). For example, when driving power is applied to a BMS in a mode in which no driving power is supplied to the BMS (inactive mode), the BMS may switch to the standby mode.

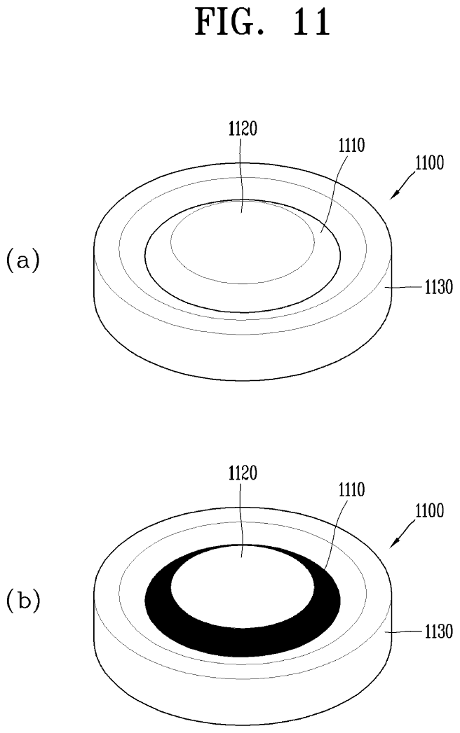

In operation S300, when all the battery packs are switched to the standby mode, the master BMS may indicate that the robot 10 is switched to the operable state, i.e., the standby mode. In this case, the master BMS may transmit to the controller 100 of the robot 10 an indication that all the battery packs have switched to the standby mode, and the controller 100 may indicate the standby mode of the robot 10 according to a predetermined notification method, thereby indicating the mode switch of the robot 10. An example of providing the user with a recognizable indication that the robot 10 has switched to the standby mode according to the power-on state of the plurality of battery packs will be described with reference to FIG. 11.

When all battery packs are powered on in operation S300, the master BMS may drive all the battery packs according to the operation state of the robot 10 (S302). For example, when the robot 10 is docked at the charging station 20 and is charged, the master BMS may start a charging operation of supplying the supplied charging current to each battery pack. On the other hand, when the robot 10 is operating to provide a specified service, the master BMS may start a discharging operation to discharge power from each battery pack to supply power to drive the robot 10.

In operation S302, when each battery pack starts charging or discharging, the master BMS may detect the operation state of each battery pack (S304). Here, the master BMS may collect information related to the operation state of each battery pack (hereinafter referred to as operation state related information) not only from the battery pack including the master BMS (i.e., the master battery pack) but also from at least one other battery pack that is communicatively connected, i.e., at least one slave battery pack. Based on the collected operation state related information, the master BMS may detect the operation state of each battery pack.

The operation state of the battery pack may include the current voltage state of the battery pack and whether the battery pack is charging or discharging. The operation state of the battery pack may also include whether the battery pack is operable. For example, when the battery pack is switched to a protection mode, the battery pack may not be operable.

Further, the charging or discharging amount, capacity, or voltage of the battery may be significantly affected by temperature. Therefore, in operation S304, the master BMS may collect information about the temperature of each battery pack as operation state related information.

In operation S304, based on the collected operation state related information about the battery packs, the master BMS may control voltage balance of the battery packs to operate at least one battery pack differently from at least one other battery pack.

As part of the voltage balance control, the master BMS may perform control to limit the charging amount or discharging amount of battery packs at higher temperatures based on the temperature of each battery pack included in the collected operation state related information. For example, the master BMS may limit the charging amount or discharging amount of battery packs at higher temperatures, or perform control to increase the charging amount or discharging amount of battery packs at low temperatures. Alternatively, based on the voltage level of each battery pack, the master BMS may reduce the charging amount and increase the discharging amount of a battery pack detected to have a higher voltage than the other battery packs. On the other hand, for a battery pack detected to have a lower voltage than the other battery packs, the master BMS may increase the charging amount and reduce the discharging amount.

In this case, the master BMS may control the BMSs of all other battery packs except the battery pack detected to have a higher voltage to turn off the discharging FETs 260 thereof. Only the discharging FET 260 of the battery pack detected to have a higher voltage may be kept on. Therefore, current may be allowed to be discharged only from the battery pack detected to have the higher voltage. Alternatively, the master BMS may control the BMSs of all the other battery packs except the battery pack detected to have a lower voltage to turn off the charging FETs 250 thereof. Only the charging FET 250 of the battery pack detected to have the lower voltage may be kept on. Therefore, only the battery pack detected to have the lower voltage may be allowed to be charged with current.

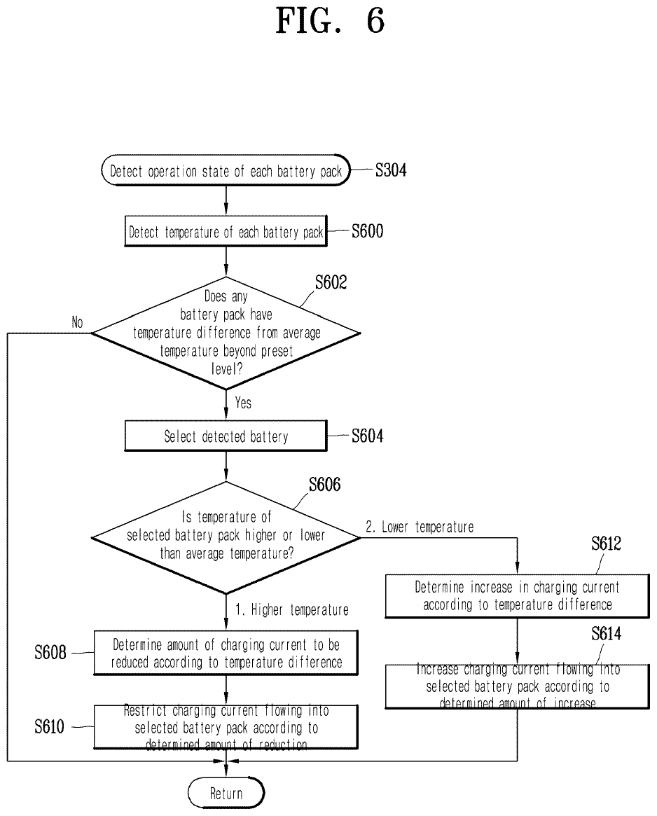

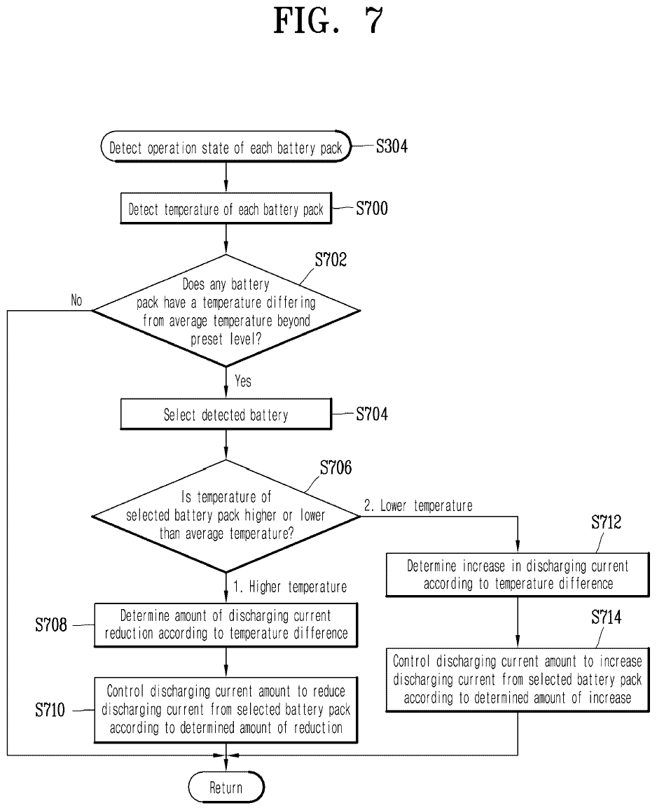

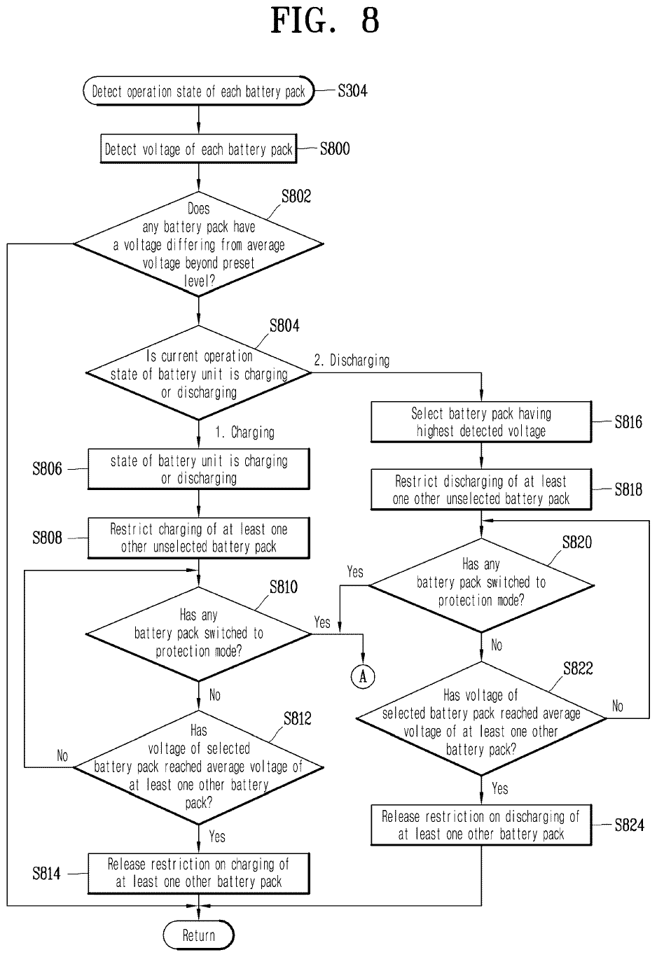

Hereinafter, the operation of the master BMS performing voltage balance control according to the temperature detected from each battery pack and the operation state (charging or discharging) of each battery pack will be described in more detail with reference to FIGS. 6 and 7. Also, the operation of the master BMS controlling the charging or discharging of each battery pack based on the voltage detected from each battery pack will be described with reference to FIG. 8.

Based on the operation state of each battery pack collected in operation S304, the master BMS may check whether there is a battery pack switched to the protection mode (S306). Where there is no battery pack switched to the protection mode as a result of the checking in operation S306, the master BMS may return to operation S304 and repeat the operations of collecting operation state related information from each battery pack and detecting the operation state of each battery pack based on the collected information.

As a result of the checking in operation S306, a battery pack switched to the protection mode may be detected. In this case, operation of the battery pack switched to the protection mode may be stopped for safety, and therefore charging current may be controlled not to be supplied or current may be controlled not to be discharged.

Therefore, when some battery packs switch to the protection mode, the battery packs switched to the protection mode are blocked from charging, and thus the charging current intended for the battery packs switched to the protection mode may be supplied to the other battery packs. Since the battery packs switched to the protection mode are also blocked from discharging, the discharging current to be discharged from the battery packs switched to the protection mode may be discharged more from the other battery packs. Accordingly, when some battery packs switch to the protection mode, voltage imbalance may occur between the other battery packs and the battery packs switched to the protection mode.

To address such voltage imbalance, the master BMS may control at least one other battery pack that has not switched to the protection mode to limit the charging or discharging of the at least one other battery pack (S308).

For example, the master BMS may limit charging or discharging to prevent the at least one other battery pack that has not switched to the protection mode from charging or discharging. In this case, the master BMS may control the BMS of the at least one other battery pack to turn off the charging FET 250 or discharging FET 260, thereby limiting the charging or discharging of the at least one other battery pack.

FIGS. 4 and 5 are exemplary diagrams illustrating an example in which, when one battery pack is switched to the protection mode, the other battery packs are controlled according to an embodiment of the present disclosure. FIG. 4 assumes that the ambient temperature around the robot 10 is 38 °C, and FIG. 5 assumes that the ambient temperature around the robot 10 is −5 °C.

Typically, a battery pack may switch to the protection mode depending on temperature. Further, the temperature of a battery pack may be different from that of other homogeneous battery packs depending on the installation location thereof.

For example, as described above, the driver 130 of the robot 10 may include at least one different component having a mechanism (e.g., a motor or an actuator) that is driven according to the intended use of the robot 10, and the operation of the driving mechanism may generate a predetermined amount of heat. Therefore, heat generated according to the operation of the driver 130 may be dissipated to the area surrounding the robot 10 having the driver 130. That is, the driver 130 may act as a heat source.

The battery unit 150 of the robot 10 according to the present embodiment includes a plurality of battery packs 111, 112, . . . , 110N operated independently. Additionally, for a compact design, internal components of the robot 10 are generally arranged adjacent to each other. Accordingly, the battery unit 150 may also be arranged adjacent to the driver 130. In this case, the distance between each battery pack of the battery unit 150 and the driver 130, i.e., the heat source, may vary.

For example, as shown in FIG. 4(a), when the battery unit 150 and the driver 130 are disposed, the first battery pack 111 may be positioned closest to the driver 130. In contrast, the N-th battery pack 110N may be positioned farthest from the driver 130. As shown in FIG. 4(a), the first battery pack 111, which is at the shortest distance from the driver 130, may reach the highest temperature (60 °C) due to the influence of the driver 130 (70 °C). On the other hand, the N-th battery pack 110N, which is at the longest distance from the driver 130, may be minimally affected by the driver 130 and thus maintain a temperature (40 °C) similar to the ambient temperature (approximately 38 °C).

When the protection temperature set for the battery packs is 55 °C, the BMS of the first battery pack 111 may switch the first battery pack 111 to the protection mode for safety. Once switched to the protection mode, the first battery pack 111 may be blocked from both charging and discharging.

Accordingly, as shown in FIG. 4(a), the charging path 211 connected to the first battery pack 111 among the charging paths 211 connected to the charging port 210 of the controller 100 may be deactivated. In addition, the discharging path 221 connected to the first battery pack 111 among the discharging paths 221 connected to the discharging port 220 of the controller 100 may be deactivated.

As such, when any one battery pack switches to the protection mode, the master BMS may detect the battery pack switched to the protection mode (i.e., the first battery pack 111) in operation S306 of FIG. 3. The master BMS may then control the BMSs of the other battery packs 112, . . . , 110N that have not switched to the protection mode to switch all the charging FETs 250 and discharging FETs 260 of the other battery packs 112, . . . , 110N that have not switched to the protection mode to the off state.

Therefore, as shown in FIG. 4(b), not only the charging path or discharging path connected to the first battery pack 111 switched to the protection mode, but also all charging paths connecting all battery packs of the battery unit 150 to the charging port 210 of the controller 100 and all discharging paths connecting all battery packs of the battery unit 150 to the discharging port 220 of the controller 100 may be deactivated. In this case, charging or discharging of the other battery packs that have not switched to the protection mode may also be stopped, similarly to some battery packs switched to the protection mode. Thus, even when some battery packs are switched to the protection mode, the voltage of the battery packs switched to the protection mode may remain equal to that of the other battery packs.

The description given above with reference to FIG. 4 assumes that a battery pack switches to the protection mode due to high temperature. However, even when the temperature of the battery pack falls below a certain level, the BMS may switch the battery pack to the protection mode for safety. FIG. 5 illustrates an example of this case.

Referring to FIG. 5, it is assumed that the ambient temperature around the robot 10 is −5 °C. In this case, for the battery unit 150 of the robot 10 disposed in the same manner as in FIG. 4, the first battery pack 111 may be positioned closest to the heat source (the driver 130), and the N-th battery pack 110N may be positioned farthest from the heat source (the driver 130) as in FIG. 4.

Accordingly, the first battery pack 111 may maintain a temperature within a preset operation temperature range (e.g., 0 °C to 55 °C) despite the subzero ambient temperature due to heat radiated from the heat source. However, the temperature of the N-th battery pack 110N may fall to a temperature (e.g., −3 °C) below 0 °C due to the effect of the subzero ambient temperature.

In this case, the BMS of the N-th battery pack 110N may switch the N-th battery pack 110N to the protection mode for safety. When switched to the protection mode, the N-th battery pack 110N may be blocked from both charging and discharging.

Thus, as shown in FIG. 5(a), the charging path 211 connected to the N-th battery pack 110N among the charging paths 211 connected to the charging port 210 of the controller 100 may be deactivated. In addition, the discharging path 221 connected to the N-th battery pack 110N among the discharging paths 221 connected to the discharging port 220 of the controller 100 may be deactivated.

As such, when any one battery pack switches to the protection mode, the master BMS may detect the battery pack switched to the protection mode (i.e., the N-th battery pack 110N) in operation S306 of FIG. 3. The master BMS may then control the BMSs of the other battery packs 112, . . . , 110N that have not switched to the protection mode to switch all the charging FETs 250 and discharging FETs 260 of the other battery packs 112, . . . , 110N to the off state.

Accordingly, as shown in FIG. 5(b), the charging paths 211 and the discharging paths 221 of all battery packs may be deactivated. Thus, charging or discharging of the other battery packs that have not switched to the protection mode may also be stopped, similarly to some battery packs switched to the protection mode. Thereby, the voltages of all battery packs in the battery unit 150 may be kept equal to each other.

Referring again to FIG. 3, when charging or discharging is restricted by controlling the FET of at least one other battery pack that has not switched to the protection mode in operation S308, the operation of the robot 10 may be stopped. For example, when discharging of all battery packs is stopped due to switching of some battery packs to the protection mode during operation of the robot 10, namely during discharge of current from the battery unit 150, the operation of the robot 10 may be stopped.

Thus, the master BMS may indicate that charging or discharging is restricted due to switching of the battery packs to the protection mode such that the user can recognize the reason for the stoppage of the operation or charging of the robot 10 (S310). For example, the master BMS may transmit, to a remote control terminal (e.g., a smartphone) of the robot 10, a notification message indicating that the preset charging or discharging is restricted or cause a preset LED to emit light via the controller 100 of the robot 10, thereby indicating the state of the robot 10.

While charging or discharging of all battery packs is restricted, the master BMS may check whether at least one battery pack switched to the protection mode has switched back to a normal mode (S312).

For example, as shown in FIG. 4, when some battery packs are switched to the protection mode due to high temperature, the battery packs may be cooled due to the restriction of the charging or discharging. When the battery packs are sufficiently cooled to a temperature at which they can operate, the battery packs may be released from the protection mode.

Alternatively, as shown in FIG. 5, when some battery packs are switched to the protection mode due to low temperature, the battery packs may be heated to a temperature at which the battery packs can operate according to changes in the surrounding environment (e.g., movement of the stopped robot 10 to a warm place). The battery packs may then be released from the protection mode. Once released from the protection mode, the battery packs may again be allowed to perform charging or discharging.

Therefore, when the at least one battery pack switched to the protection mode has switched to the normal mode as a result of the checking in operation S312, the master BMS may release the charging or discharging restrictions on at least one other battery pack which was restricted for voltage balance for the at least one battery pack switched to the protection mode. To this end, the master BMS may control the BMSs of the at least one other battery pack such that the charging FETs 250 and discharging FETs 260 are turned on again. Accordingly, simultaneous charging or simultaneous discharging of all battery packs, including the battery packs released from the protection mode, may be resumed (S314).

The master BMS may also check whether a power-off signal has been input for the robot 10 (S316). When the power-off signal has not been input, the master BMS may proceed to operation S304 to detect the operation state of each battery pack. Then, it may proceed to operation S306 to check for a battery pack switched to the protection mode. The master BMS may repeat operations S308 to S314 of restricting charging and discharging of each battery pack based on the result of the checking in operation S306 and resuming the charging or discharging of each battery pack based on whether battery packs switched to the protection mode have switched to the normal mode.

When the power-off signal for the robot 10 is input in operation S316, the master BMS may power off each battery pack S318.

In this case, the master BMS may check whether all the battery packs have been powered off. Here, the power-off state of the battery pack may mean that no operating power is supplied to the BMS of the battery pack, that is, the BMS is in a deactivated state. When the BMS is deactivated, the charging gate driving voltage and discharging gate driving voltage may not be applied to the charging FET 250 and discharging FET 260, and charging or discharging of each battery cell may be stopped.

The master BMS may check whether all slave battery packs are powered off and may then turn off the power thereof. Accordingly, all battery packs may be powered off to prevent the battery packs from continuing discharging or charging.

Alternatively, the power-off state of the battery pack may mean that the discharging gate driving voltage is not applied to the discharging FET 260. In this case, since current is not discharged from any of the battery packs, the robot 10 stops operating, but power may still be supplied to the BMS of each battery pack. In this case, by maintaining the charging gate driving voltage applied to the charging FET 250, the BMS may allow the robot 10 to remain stopped while keeping the current from a docked charging station 20 available to each battery pack. In other words, the power-off state mean that each battery pack can be charged with the robot 10 powered off.

A description has been given above of an operation procedure in which the master BMS controls at least one other BMS to restrict the charging and discharging of the at least one other battery pack such that the voltage of a battery pack that has switched to the protection mode becomes equal to the voltage of the at least one other battery pack.

However, the operation procedure described above may also be performed by the controller 100 of the robot 10 instead of the master BMS. In this case, the controller 100 may perform the operations described above in place of the master BMS. Further, when the operations are performed by the controller 100, the controller 100 may control the charging and discharging of all battery packs regardless of the distinction of the master and slaves.

A description has been given above of an example in which, when at least one battery pack switches to the protection mode due to operational abnormality or temperature, the charging or discharging of all battery packs is restricted. However, the restriction on the charging or discharging of at least one other battery pack that has not switched to the protection mode may be applied according to user selection.

For example, when the robot is performing an emergency service, or when the robot performs emergency charging to provide the emergency service, the user may choose to maintain the discharging or charging state of the other battery packs that have not switched to the protection mode, despite some battery packs switched to the protection mode.

To this end, when at least one battery pack switched to the protection mode is detected as a result of the checking in operation S306 of FIG. 3, the master BMS may inquire, via a terminal for remote control of the robot 10 or a message indicated through an audible signal or a display (not shown), whether to maintain the charging or discharging state or to restrict the charging or discharging of at least one other battery pack that has not switched to the protection mode.

When restriction on the charging or discharging is selected in response to the inquiry, the master BMS may restrict the charging or discharging of the at least one other battery pack that has not switched to the protection mode (by turning on or off the FET) as described above with reference to FIG. 3.

On the other hand, when the user does not select restriction on the charging or discharging of the at least one other battery pack in response to the inquiry, the charging or discharging state of the other battery packs, excluding the battery packs switched to the protection mode, may be maintained.

In this case, when the battery packs are in the discharging state, the master BMS may supply the current discharged from the other battery packs to the controller 100 to maintain the operation state of the robot 10. In this case, the voltages of the battery packs switched to the protection mode may remain unchanged, while the voltages of the other battery packs may continue to decrease. In this case, the master BMS may detect and store the voltages of the battery packs switched to the protection mode.

When some battery packs switched to the protection mode are released from the protection mode during the operation of the robot 10, the master BMS may restrict the charging and discharging of the released battery packs (by, for example, controlling the BMSs of the battery packs to turn off the charging FETs 250 and discharging FETs 260 of the battery packs). Therefore, even when the robot 10 finishes operation and begins to be charged, the other battery packs may be charged, while charging of the battery packs released from the protection mode may still be restricted.

The master BMS may check the average voltage of the other battery packs. It may continue to restrict the charging and discharging of the battery packs released from the protection mode until the average voltage of the other packs becomes equal to the voltage of the battery packs released from the protection mode. Once the average voltage of the other packs rises through charging to equal the voltage of the battery packs released from the protection mode, the master BMS may release the restriction on the charging and discharging of the released battery packs (by, for example, turning on the charging FETs 250 and discharging FETs 260 of the released battery packs).

In other words, when the voltage of some battery packs released from the protection mode is equal to the voltage of the other battery packs that have not switched to the protection mode, the battery packs released from the protection mode may be released from the restriction on the charging and discharging. When the voltages of all battery packs become equal, all battery packs may be charged simultaneously.

When the battery packs are in the charging state, the master BMS may supply current to the other battery packs that have not switched to the protection mode. In this case, the voltages of the battery packs switched to the protection mode may remain unchanged, while the voltages of the other battery packs may continue to rise. In this case, the master BMS may detect and store the voltages of the battery packs switched to the protection mode.

When some battery packs switched to the protection mode are released from the protection mode, the master BMS may restrict the charging and discharging of the released battery packs (by, for example, controlling the BMSs of the battery packs to turn off the charging FETs 250 and discharging FETs 260 of the battery packs). Therefore, even when charging of the robot 10 is finished and discharging begins, current may be discharged from the other battery packs, while current may not be discharged from the battery packs released from the protection mode.

The master BMS may check the average voltage of the other battery packs that continue discharging due to the operation of the robot 10. Once the average voltage of the other packs decreases through discharging to equal the voltage of the battery packs released from the protection mode, the master BMS may release the restriction on the charging and discharging of the released battery packs (by, for example, turning on the charging FETs 250 and discharging FETs 260 of the released battery packs).

In other words, when the voltage of some battery packs released from the protection mode is equal to the voltage of the other battery packs that have not switched to the protection mode, the battery packs released from the protection mode may be released from the restriction on the charging and discharging. When the voltages of all battery packs become equal, all battery packs may discharge simultaneously.

A description has been given above with reference to FIG. 3 regarding an example of detecting the operation state of battery packs to check whether there is any battery pack that has switched to the protection mode. Additionally, based on the operation state related information detected in operation S304 of FIG. 3, the master BMS may control the amount of charging or discharging of each battery pack to suppress switching of battery packs to the protection mode due to temperature.

FIGS. 6 and 7 are flowcharts illustrating operation procedures in which the robot 10 according to an embodiment of the present disclosure restricts charging or discharging current according to the temperature of the battery packs to prevent the temperature from causing switching to the protection mode during charging or discharging. Battery packs generate heat during charging or discharging due to movement of ions, which is a heat generation process. A higher charging or discharging amount may cause more heat to be generated. Accordingly, by controlling the charging or discharging amount, battery packs may be suppressed not to switch to the protection mode.

FIG. 6 assumes that the operation state of the battery packs is the charging state.

Referring to FIG. 6, when operation state related information including temperature is collected from each battery pack in FIG. 3, the master BMS may detect the temperature of each battery pack based on the collected operation state related information (S600). Then, the master BMS may calculate the average temperature of the battery packs and detect whether any battery pack has a temperature differing from the calculated average temperature beyond a predetermined level (S602). When such a battery pack is detected, the detected battery pack may be selected as a control target battery pack for which the amount of charging current is to be controlled (S604).

Thus, as shown in FIG. 4, in operation S604, the master BMS may select the first battery pack 111 with a higher temperature than the other battery packs as the control target battery pack. Alternatively, as shown in FIG. 5, in operation S604, the master BMS may select the N-th battery pack 110N with a lower temperature than the other battery packs as the control target battery pack.

Once the control target battery pack is selected in operation S604, the master BMS may determine whether the temperature of the selected battery pack is higher or lower than the average temperature of the battery packs (S606).

When the temperature of the control target battery pack is higher than the average temperature, the master BMS may determine the amount of charging current to be reduced based on the temperature difference between the temperature of the selected battery pack and the average temperature (S608). Based on the determined amount to be reduced, the master BMS may control the BMS of the control target battery pack to reduce the amount of charging current supplied to the control target battery pack (S610).

The charging current may be restricted according to the magnitude of the charging gate driving voltage applied to the charging FET 250. For example, the master BMS may apply a lower charging gate driving voltage to the control target battery pack for a larger temperature difference, thereby reducing the maximum amount of charging current supplied to the control target battery pack. The minimum charging gate driving voltage may be higher than a threshold voltage set for the charging FET 250.

Alternatively, as described above with reference to FIG. 2, a variable resistor having resistance varied by the control of the BMS may be disposed between the charging path and the charging FET 250. In this case, the master BMS may control the variable resistor to increase the resistance as the temperature difference between the temperature of the control target battery pack and the average temperature increases, thereby reducing the maximum amount of charging current supplied to the control target battery pack. As a result, the charging current supplied to the battery pack may decrease.

Here, the charging gate driving voltage or variable voltage determined according to the difference between the temperature of the control target battery pack and the average temperature may be determined as the charging current reduction in operation S608. In this case, the memory 120 may store a charging current reduction table that lists different charging gate driving voltages or different variable voltages corresponding to different temperature differences between the temperature of the control target battery pack and the average temperature. Thus, in operation S608, the master BMS may determine the charging gate driving voltage or variable voltage based on the charging current reduction table stored in the memory. Then, in operation S610, the master BMS may control the BMS of the control target battery pack to reduce the maximum amount of charging current supplied to the control target battery pack according to the determined charging gate driving voltage or variable voltage. Then, the amount of charging current may decrease and the rise of the temperature of the control target battery pack may be slowed down.

On the other hand, when the determination in operation S706 indicates that the temperature of the control target battery pack is lower than the average temperature, the master BMS may determine an increase in the charging current based on the difference between the temperature of the selected control target battery pack and the average temperature (S612). The master BMS may then control the BMS of the control target battery pack to increase the amount of charging current supplied to the control target battery pack according to the determined charging current increase (S614).

Here, the charging gate driving voltage or variable voltage determined based on the difference between the temperature of the control target battery pack and the average temperature may be determined as the increase in the charging current in operation S612. In this case, the memory 120 may store a charging current increase table that lists different charging gate driving voltages or different variable voltages corresponding to different temperature differences between the temperature of the control target battery pack and the average temperature. Thus, in operation S612, the master BMS may determine the charging gate driving voltage or variable voltage based on the charging current increase table stored in the memory.

Then, in operation S614, the master BMS may control the BMS of the control target battery pack to increase the maximum amount of charging current supplied to the control target battery pack according to the determined charging gate driving voltage or variable voltage. Then, the amount of charging current may increase, and the decrease of the temperature of the control target battery pack may be slowed down.

FIG. 7 assumes that the operation state of the battery packs is the discharging state.

Referring to FIG. 7, the master BMS may detect the temperature of each battery pack in the same manner as in FIG. 6 (S700). Then, the master BMS may calculate the average temperature of the battery packs and detect whether any battery pack has a temperature differing from the calculated average temperature beyond a predetermined level (S702). When such a battery pack is detected, the detected battery pack may be selected as a control target battery pack for which the amount of charging current is to be controlled (S704).

Once the control target battery pack is selected in operation S704, the master BMS may determine whether the temperature of the selected control target battery pack is higher or lower than the average temperature of the battery packs (S706).

When the temperature of the control target battery pack is higher than the average temperature, the master BMS may determine the amount of discharging current reduction based on the temperature difference between the temperature of the selected battery pack and the average temperature (S708). Based on the determined amount to be reduced, the master BMS may control the BMS of the control target battery pack to reduce the amount of discharging current from the control target battery pack (S710).

Similar to the discharging current, the discharging current may be restricted according to the magnitude of the discharging gate driving voltage applied to the discharging FET 260. The master BMS may apply a lower discharging gate driving voltage to the control target battery pack for a larger temperature difference, thereby reducing the maximum amount of discharging current discharged from the control target battery pack. The minimum discharging gate driving voltage may be higher than a threshold voltage set for the discharging FET 260.

Alternatively, as described above with reference to FIG. 2, a variable resistor having resistance varied by the control of the BMS may be disposed between the discharging path and the discharging FET 260. In this case, the master BMS may control the variable resistor to increase the resistance as the temperature difference between the temperature of the control target battery pack and the average temperature increases, thereby reducing the maximum amount of discharging current from the control target battery pack. As a result, the discharging current discharged from the battery pack may decrease.

Here, the discharging gate driving voltage or variable voltage determined according to the difference between the temperature of the control target battery pack and the average temperature may be determined as the discharging current reduction in operation S708. In this case, the memory 120 may store a discharging current reduction table that lists different discharging gate driving voltages or different variable voltages corresponding to different temperature differences between the temperature of the control target battery pack and the average temperature. Thus, in operation S708, the master BMS may determine the discharging gate driving voltage or variable voltage based on the discharging current reduction table stored in the memory. Then, in operation S710, the master BMS may control the BMS of the control target battery pack according to the determined discharging gate driving voltage or variable voltage. Then, the amount of discharging current may decrease and the rise of the temperature of the control target battery pack may be slowed down.

On the other hand, when the determination in operation S706 indicates that the temperature of the control target battery pack is lower than the average temperature, the master BMS may determine an increase in the discharging current based on the difference between the temperature of the selected control target battery pack and the average temperature (S712). The master BMS may then control the BMS of the control target battery pack to increase the amount of discharging current from the control target battery pack according to the determined discharging current increase (S714).

Here, the discharging gate driving voltage or variable voltage determined based on the difference between the temperature of the control target battery pack and the average temperature may be determined as the increase in the discharging current in operation S712. In this case, the memory 120 may store a discharging current increase table that lists different discharging gate driving voltages or different variable voltages corresponding to different temperature differences between the temperature of the control target battery pack and the average temperature. Thus, in operation S712, the master BMS may determine the discharging gate driving voltage or variable voltage based on the discharging current increase table stored in the memory.

Then, in operation S714, the master BMS may control the BMS of the control target battery pack according to the determined discharging gate driving voltage or variable voltage. Then, the amount of discharging current may increase, and the decrease of the temperature of the control target battery pack may be slowed down.

The processes described with reference to FIGS. 6 and 7 may be repeated as the master BMS proceeding to operation S306 of FIG. 3 checks whether any battery pack has switched to the protection mode, and performs operation S304 of detecting the operation state of each battery pack according to the result of the checking indicating that there is no battery pack having switched to the protection mode.

In the robot 10 according to the embodiment of the present disclosure, the master BMS may also control charging or discharging of each battery pack for voltage balance based on the voltages of the respective battery packs detected while detecting the operation state of each battery pack in operation S304 of FIG. 3.

FIG. 8 is a flowchart illustrating an operation procedure in which charging or discharging of at least one battery pack is restricted according to the voltage difference among the battery packs in the robot 10 according to an embodiment of the present disclosure.

Referring to FIG. 8, the master BMS of the robot 10 according to the embodiment may first detect the voltage of each battery pack from the operation state related information collected from each battery pack (S800). Then, the master BMS may detect a battery pack whose detected voltage is higher or lower than the average voltage of at least one other battery pack by a preset level or higher (S802). For example, when any of the battery packs included in the battery unit 150 is replaced, the voltage of the replaced battery pack may be higher or lower than the average voltage of at least one other battery pack by a preset level.

When, as a result of operation S802, at least one battery pack has a voltage higher or lower than the average voltage by the preset level, the master BMS may check the current operation state of the battery unit 150 (S804). Here, the operation state of the battery unit 150 may be classified as a charging state, in which current is supplied to each battery pack, or a discharging state, in which current is discharged from each battery pack. The discharging state may correspond to a state in which the robot 10 operates to provide services according to a specified purpose.

When, as a result of the checking in operation S804, the operation state of the battery unit 150 is the charging state, the master BMS may select the battery pack having the lowest voltage among the battery packs detected in operation S802 (S806). The master BMS may then restrict charging of the other battery packs, excluding the selected battery pack (for example, it may turn off the charging FET 250) (S808). Accordingly, charging current may be supplied to only the battery pack having the lowest voltage among the at least one battery pack detected in operation S802.

The master BMS may check whether any of the battery packs in the battery unit 150 has switched to the protection mode (S810). When there is a battery pack having switched to the protection mode, the master BMS may proceed to operation S308 of FIG. 3 and restrict not only charging and discharging of battery packs switched to the protection mode but also charging and discharging of the other battery packs. Subsequent operations after operation S308 may then be performed.

However, when no battery pack has switched to the protection mode as a result of the checking in operation S810, the master BMS may check whether the current selected battery pack, that is, the only battery pack receiving charging current, has reached the average voltage of at least one other battery pack restricted from charging (S812). When the voltage of the selected battery pack has not reached the average voltage of the at least one other battery pack restricted from charging, the restriction of the at least one other battery pack from the charging current may be maintained.

When the voltage of the selected battery pack has reached the average voltage of the at least one other battery pack restricted from charging, the master BMS may release the at least one other battery pack from the charging restriction (for example, it may turn on the charging FET 250) (S814). Accordingly, simultaneous charging of all battery packs may be resumed.

The master BMS may then proceed to operation S306 of FIG. 3 to check whether any battery pack has switched to the protection mode. When no battery pack has switched to the protection mode, operation S304 of detecting the operation state of each battery pack may be performed again, and the process of FIG. 8 may be repeated.

When, as a result of the checking in operation S804, the operation state of the battery unit 150 is the discharging state, the master BMS may select a battery pack having the highest voltage among the battery packs detected in operation S802 (S816). The master BMS may then restrict discharging of the other battery packs, excluding the selected battery pack (for example, it may turn off the discharging FET 260) (S818). Accordingly, current may be discharged from only the battery pack having the highest voltage among at least one battery pack detected in operation S802.

The master BMS may check whether any battery pack in the battery unit 150 has switched to the protection mode (S820). When any battery pack has switched to the protection mode, the master BMS may proceed to operation S308 of FIG. 3 and restrict not only charging and discharging of battery packs switched to the protection mode but also charging and discharging of the other battery packs. Subsequent operations after operation S308 may then be performed.

However, when no battery pack has switched to the protection mode as a result of the checking in operation S820, the master BMS may check whether the current selected battery pack, that is, the only battery pack from which current is discharged, has reached the average voltage of at least one other battery pack restricted from discharging (S822). When the voltage of the selected battery pack has not reached the average voltage of the at least one other battery pack restricted from discharging, the restriction of the at least one other battery pack from the discharging current may be maintained.

When the voltage of the selected battery pack has reached the average voltage of the at least one other battery pack restricted from discharging, the master BMS may release the at least one other battery pack from the discharging restriction (for example, it may turn on the discharging FET 260) (S824). Accordingly, simultaneous discharging of all battery packs may be resumed.

The master BMS may then proceed to operation S306 of FIG. 3 to check whether any battery pack has switched to the protection mode. When no battery pack has switched to the protection mode, operation S304 of detecting the operation state of each battery pack may be performed again, and the process of FIG. 8 may be repeated.

In the description of FIG. 8 given above, when the battery unit 150 is being charged, a low voltage battery pack having the lowest voltage is detected, and charging of the other battery packs except for the low voltage battery pack is restricted to resolve voltage imbalance among the battery packs. Alternatively, when the battery unit 150 is being charged, a high voltage battery pack having the highest voltage may be detected, and charging of the high voltage battery pack may be restricted to resolve voltage imbalance among the battery packs. That is, according to an embodiment of the present disclosure, when the battery unit 150 is being charged, one of at least one other battery pack except for the low voltage battery pack or the high voltage battery pack may be restricted from charging to resolve the voltage imbalance.

Similarly, in the description of FIG. 8 given above, when the battery unit 150 is discharging, a high voltage battery pack having the highest voltage is detected, and discharging of the other battery packs except for the high voltage battery pack is restricted to resolve voltage imbalance among the battery packs. Alternatively, when the battery unit 150 is discharging, a low voltage battery pack having the lowest voltage may be detected, and the detected low voltage battery pack may be restricted from discharging to resolve the voltage imbalance. That is, according to an embodiment of the present disclosure, when the battery unit 150 is discharging, one of at least one other battery pack except for the high voltage battery pack or the low voltage battery pack may be restricted from discharging to resolve the voltage imbalance.

As described above, the BMS of the master battery pack, that is, the master BMS, may control the charging or discharging of at least one slave battery pack for voltage balance. However, the master battery pack may also switch to the protection mode due to temperature or operational abnormalities.

When a battery pack switches to the protection mode, the BMS of the battery pack may be restricted from operating. Accordingly, when the master battery pack switches to the protection mode, the master BMS may be restricted from operating. In this case, it may fail to perform voltage balance control.

Accordingly, in the robot 10 according to an embodiment of the present disclosure, when the master battery pack switches to the protection mode, one of at least one slave battery pack may be switched to become the master battery pack. In this case, the existing master BMS may be switched to a slave BMS as the corresponding battery pack changes to a slave battery pack.

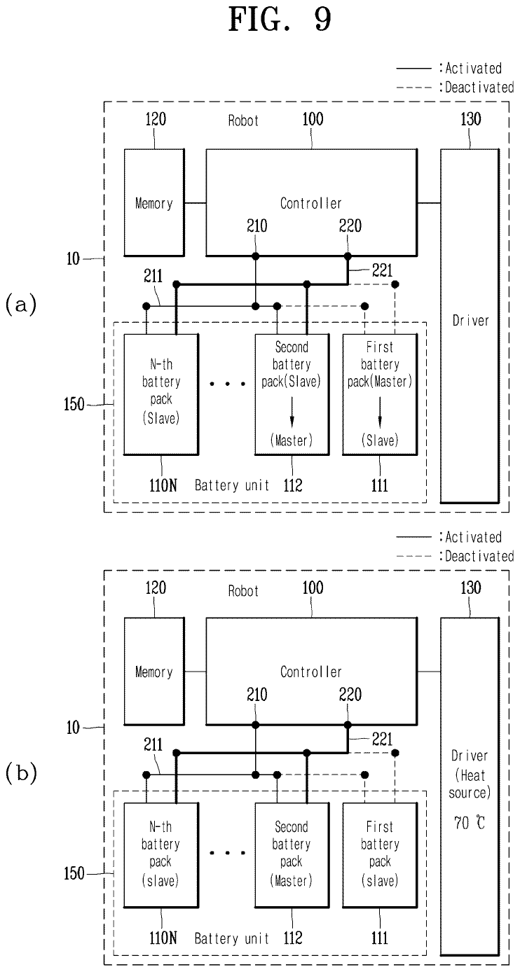

FIG. 9 is an exemplary diagram illustrating an example in which switching to a master battery pack is performed according to switching to a protection mode in the robot 10 according to an embodiment of the present disclosure.

First, FIG. 9(a) illustrates that the first battery pack 111, which is set as the master, switches to the protection mode due to temperature, operational abnormality, or other reasons. Once the first battery pack 111 switches to the protection mode, it may be restricted from both charging and discharging, and the charging path and discharging path connecting the first battery pack 111 and the charging port 210 or discharging port 220 of the controller 100 may be deactivated.

In this way, when a battery pack set as the master switches to the protection mode, one of some other battery packs that have not switched to the protection mode, that is, at least one slave battery pack, may be changed to the master.

Here, the master may be selected by the controller 100 of the robot 10. Alternatively, any one of the plurality of battery packs may be selected automatically according to a preset condition. For example, when priorities are assigned to the battery packs to set a master, one slave battery pack may be selected as the master according to the priorities.

Alternatively, the preset condition may be determined based on the states of the battery packs. For example, a battery pack having voltage closest to the average voltage among the battery packs may be selected as the master. Alternatively, a battery pack whose detected temperature is closest to the average temperature may be set as the master.

According to these conditions or preset priorities, the second battery pack 112 may be selected as the master as shown in FIG. 9(a). Thus, through master-slave switching, as shown in FIG. 9(b), the first battery pack 111 may be switched from the master battery pack to a slave battery pack, and the second battery pack 112 may be switched from the slave battery pack to the master battery pack. Accordingly, the master BMS may also be changed from the BMS of the first battery pack 111 to the BMS of the second battery pack 112, and operations according to at least one of FIGS. 3, 6, 7, and 8 may be performed by the BMS of the second battery pack 112 such that voltage balance among the battery packs may be achieved.

As described above, when the battery unit 150 includes a plurality of battery packs operating individually, the battery packs may be powered off or on individually according to a power-off or power-on signal.

However, when the duration of input on the power key for applying the power-off or power-on signal is insufficient, for example, when the duration of input on the power key is excessively short, some of the battery packs may fail to be powered off or on. In this case, battery packs that are not powered off or on may continue charging or discharging, resulting in voltage imbalance with other battery packs that have normally powered off or on.

For the robot 10 according to an embodiment of the present disclosure, to prevent this issue, when a power-off or power-on signal is input, the master BMS may manage power-off or power-on of each slave battery pack.

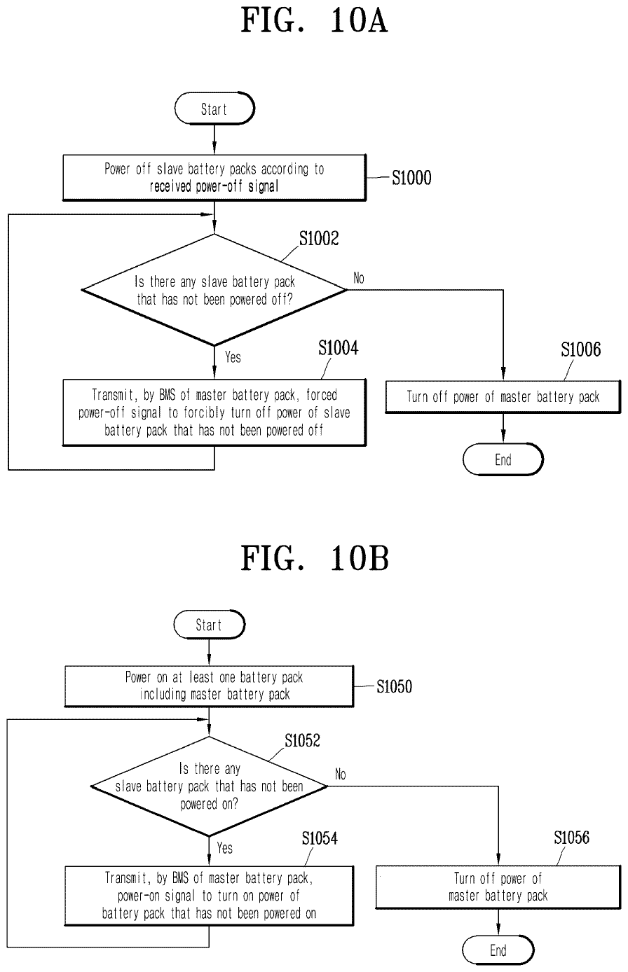

FIGS. 10A and 10B are flowcharts illustrating operation procedures in which the master BMS of the robot 10 according to an embodiment of the present disclosure manages power-off or power-on of each battery pack according to a power-off or power-on signal.

Here, the power-on or power-off signal may be input through a key input unit of a switch provided in the robot 10. In this case, when the power-on or power-off signal is input through the key input unit, the controller 100 of the robot 10 may transmit the input power-on or power-off signal to the battery unit 150 to transmit the same to each battery pack in the battery unit 150.

First, FIG. 10A illustrates a operation procedure in which the master BMS manages the power of each slave battery pack to be off when a power-off signal is input (e.g., operation S318 of FIG. 3).

When the power-off signal is input, each battery pack may be powered off according to the received power-off signal. In this case, the power-off of each battery pack may be performed individually when the BMS of each battery pack individually turns off power according to the power-off signal delivered through the controller 100 (S1000).

The battery packs powered off in operation S1000 may be restricted to slave battery packs. That is, the BMS of the master battery pack, i.e., the master BMS, may maintain the power-on state in operation S1000 even when it receives the power-off signal.

When at least one slave battery pack is powered off according to the power-off signal in operation S1000, the master BMS may detect any slave battery pack that has not been powered off (S1002).

When there is a slave battery pack that has not been powered off as a result of the detection in operation S1002, the master BMS may transmit a preset control signal (forced power-off signal) to the BMS of the slave battery pack that has not been powered off to turn off the power. In other words, when there is a slave battery pack that has not been powered off despite the power-off signal input, the master BMS may control the BMS of the battery pack to forcibly turn off the power (S1004). Then, it may proceed to operation S1002 to detect any other slave battery pack that has not been powered off.

When there is no slave battery pack that has not been powered off as a result of the detection in operation S1002, the master BMS may turn off the power of the master battery pack (S1006). Accordingly, when a power-off signal is input, the master BMS of the robot 10 according to an embodiment of the present disclosure may turns off the power thereof only after all of the at least one other battery pack (slave battery pack) is powered off. Accordingly, in the robot 10 according to an embodiment of the present disclosure, when the power-off signal is input, all battery packs may be powered off.

To this end, the controller 100 of the robot 10 may control an indicator, which is configured to indicate the power-on or power-off state of the robot 10, to indicate that the plurality of battery packs is in a power-off state only when all the slave packs and the master battery pack are all powered off. A similar issue may arise when input is provided through the power-on key on the robot 10. That is, when the duration of input on the power key is insufficient, for example, when the duration of input on the power key is excessively short, some of the battery packs may fail to be powered on. In this case, since the robot 10 is driven only by the current discharged from the battery packs that are powered on, issues such as power imbalance between the battery packs and overcharging or over-discharging of the battery packs that are powered on may arise.

FIG. 10B illustrates a operation procedure in which the master BMS manages the power of each slave battery pack to be on when a power-on signal is input (e.g., operation S300 of FIG. 3).

When the power-on signal is input, each battery pack may be powered on according to the received power-on signal. In this case, the power-on of each battery pack may be performed individually when the BMS of each battery pack individually turns on power according to the power-on signal delivered through the controller 100 (S1050). Accordingly, the master pack and at least one slave battery pack may be powered on.

When the master pack is powered on in operation S1050, the master BMS may detect any slave battery pack that has not been powered on (S1052).

When there is a slave battery pack that has not been powered on as a result of the detection in operation S1052, the master BMS may transmit a preset control signal (forced power-on signal) to power on the BMS of the slave battery pack that has not been powered on. Thus, even when some slave battery packs are powered on as the power-on signal is not delivered, the forced power-on signal from the master BMS may turn on the power of the slave battery pack that has not been powered on (S1054). The master BMS may then proceed to operation S1052 to detect any other slave battery pack that has not been powered on.

When there is no slave battery pack that has not been powered on as a result of the detection in operation S1052, the master BMS may indicate that all battery packs are powered on (S1056). For example, when all battery packs are powered on, the master BMS may provide the user with a recognizable indication that the robot is in an operable state (standby mode) according to an operation instruction.

For example, the master BMS may transmit, through the controller 100, a notification signal indicating that the robot 10 is in the standby mode to the terminal for remote control of the robot 10. Alternatively, the controller 100 may be operated to display, on the display (not shown) of the robot 10, a notification message or information indicating that the robot is in the standby mode. Alternatively, at least one LED provided in the light output unit of the robot 10 may be controlled to emit light to indicate that the robot 10 is in an operable state.

In this case, the notification signal, notification message, or the light signal from the LED may indicate that the robot 10 is in the operable state (standby mode), i.e., that the robot 10 is powered on (in the power-on state). According to an embodiment of the present disclosure, the robot 10 equipped with a plurality of battery packs may indicate that power is on only when all the battery packs are powered on.

To this end, the controller 100 of the robot 10 may control an indicator, which is configured to indicate the power state or power-off state of the robot 10, to indicate that the plurality of battery packs is in a power-on state only when all the slave packs and the master battery pack are all powered on.

FIG. 11 illustrates an example of the power key configured to receive a power-on or power-off signal as described with reference to FIG. 10B. In the illustrated example, the key is provided on the body of the robot 10.

Referring to FIG. 11(a), a power key 1100 according to the embodiment may include a key input unit 1120 configured to receive a touch input or press input from the user to input a power-on or power-off signal, a body part 1130 supporting the key input unit 1120 and connected to the body of the robot 10, and an indicator 1110 formed around the key input unit 1120 to indicate the power state (the power-on or power-off state) of the robot 10 according to the input through the key input unit 1120.

The key input unit 1120 may be formed as a touch or push switch as shown in FIG. 11(a). When the key input unit 1120 formed as a switch is touched or pressed by the user for a predetermined time or longer, a power-on signal to power on the battery unit 150 or a power-off signal to power off the battery unit 150 may be input to the battery unit 150 through the controller 100. In addition, the indicator 1110 may be implemented as at least one LED disposed around the key input unit 1120 formed as a push switch.

For example, when the robot 10 is not powered on, the indicator 1110 of the power key 1100 may not emit light as shown in FIG. 11(a). Here, the powered-on state of the robot 10 may correspond to a state in which the power of all battery packs included in the battery unit 150 is on, as described with reference to FIG. 10B.

For example, when a user presses or touches the key input unit 1120 to input a power-on signal, each battery pack in the battery unit 150 may be powered on according to the operation procedure illustrated in FIG. 10B. In this case, when at least one battery pack fails to be powered on, the master BMS may not proceed to operation S1056 of FIG. 10B, and accordingly the indicator 1110 of the power key 1100 may not emit light.

In this case, in operation S1054 of FIG. 10B, the master BMS may turn on the power of at least one battery pack that has not been powered on. Then, all battery packs in the battery unit 150 may be powered on, and the master BMS may proceed to operation S1056 of FIG. 10B to cause the indicator 1110 of the power key 1100 to emit light (for example, it may control the controller 100 to cause the indicator 1110 to emit light). Thus, as shown in FIG. 11(b), the indicator 1110 of the power key 1100 may emit light only when all battery packs are powered on, such that the user may recognize that the robot 10 is in a powered-on state.

When the robot 10 is powered on, it may be driven according to a user request or pre-established settings to provide services to the user. When the robot 10 is driven in this way, the indicator 1110 of the power key 1100 may keep emitting light. When the user presses or touches the key input unit 1120 again in this state, the user input may be an instruction to power off the robot 10.

When a power-off signal is input in this manner, all slave battery packs, except for the master battery pack, may proceed to operation S1000 of FIG. 10A to turn off power. The master BMS may then check whether any slave battery pack has not been powered off despite the input of the power-off signal. When any slave battery pack has not been powered off, the master BMS may control the BMS of the battery pack to forcibly turn off the power (operations S1002 and S1004). Finally, the master BMS may turn off its own power, thereby turning off the power of the master battery pack (operation S1006). In this case, the master BMS may turn off the indicator 1110 of the power key 1100 simultaneously (by, for example, controlling the controller 100 to turn off the indicator 1110) while turning off the power thereof. Accordingly, as shown in FIG. 11(a), the indicator 1110 of the power key 1100 may be turned off. That is, the indicator 1110 of the power key 1100 may be turned off when all battery packs, including the master battery pack, are powered off.

Regarding the robot 10 according to an embodiment of the present disclosure, it has been described above with reference to FIG. 10B that when an input is provided through the key input unit 1120 of the power key 1100, the master battery pack is powered on, and the BMS of the powered-on master battery pack, i.e., the master BMS, may check whether at least one other slave battery pack is powered on.

However, the procedure of FIG. 10B assumes that the master battery pack is powered on in response to the input of the power-on signal. When the master battery pack is not powered on despite the input of the power-on signal, the procedure of FIG. 10B may not be performed.

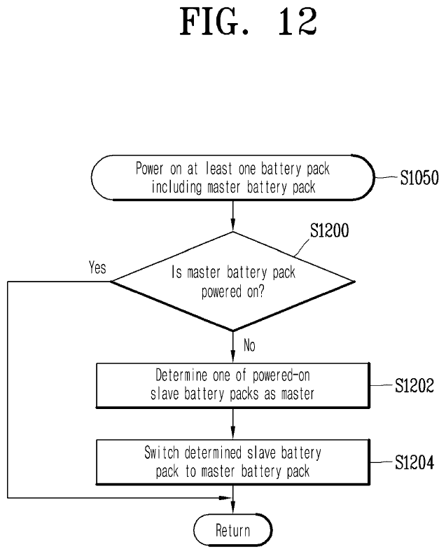

To address this issue of failing to power on the master battery pack, the robot 10 according to an embodiment of the present disclosure may perform master-slave switching as described above with reference to FIG. 9. FIG. 12 is a flowchart illustrating an operation procedure in which master switching is performed when the master battery pack is not powered on.

Referring to FIG. 12, when the procedure of turning on the power of the master battery pack and at least one other battery pack begins in response to the input on the power key in FIG. 10B, the BMS of each battery pack powered on in response to the input of the power-on signal may check whether the master battery pack is powered on (S1200).

For example, when the master battery pack is successfully powered on, the master BMS may transmit a signal indicating that the master BMS has been powered on to the BMSs of other slave battery packs which have been powered on. Alternatively, the BMS of each powered-on slave battery pack may transmit a signal for invoking the master BMS to the other connected BMSs and check whether a response to the signal is received, thereby checking whether the master BMS has been powered on.

When it is determined as a result of the checking in operation S1200 that the master battery pack has been powered on, the master BMS may proceed to operation S1052 of FIG. 10B to check whether any slave battery pack has not been powered on. However, when the master battery pack is not detected to be powered on as a result of the checking in operation S1200, the BMSs of the currently powered-on slave battery packs may determine one of the slave battery packs as a master battery pack (S1202).

For example, the master battery pack may be determined according to preset master priorities of the battery packs as described above with reference to FIG. 9. Alternatively, based on preset conditions such as, for example, the voltage or temperature of each powered-on slave battery pack, one of the slave battery packs may be determined as the master battery pack. Also, the BMS of the battery pack determined as the master battery pack may be determined as a new master BMS.

Once a new master battery pack and master BMS are determined in operation S1202, the previous master battery pack may be switched to a slave battery pack. The battery pack determined as the new master may be switched to the master battery pack. Accordingly, the previous master BMS may be switched to a slave BMS (S1204).

The BMS of the newly determined master battery pack, i.e., the master BMS, may then proceed to operation S1052 of FIG. 10B to check whether any slave battery pack has not been powered on. Thus, at least one battery pack that has not been powered on, including the former master pack now switched to a slave battery pack, may be powered on by the BMS newly determined as the master BMS.

A configuration has been described above in which the BMS of the master battery pack controls the BMSs of other slave battery packs. Alternatively, the controller 100 of the robot 10 may perform the function of the master BMS. In this case, when at least one battery pack is switched to the protection mode, the controller 100 of the robot 10 may restrict charging and discharging of at least one other battery pack according to the operation procedure illustrated in FIG. 3, to prevent voltage imbalance with the battery pack switched to the protection mode. Further, the controller 100 may control the charging or discharging amount of each battery pack based on the temperature of each battery pack during charging or discharging according to FIGS. 6 to 7, or control charging or discharging of other battery packs based on the voltage of each battery pack according to FIG. 8.

While it has been described above that multiple battery packs switch to the protection mode according to the operation state thereof, the controller 100 of the robot 10 may determine whether to switch to the protection mode. In this case, the controller 100 may detect the operation state of each battery pack, such as temperature. When any battery pack exceeds a preset operating temperature range, the controller may switch the battery pack to the protection mode. That is, the switching of each battery pack to the protection mode may be performed autonomously by the BMS of each battery pack, or may be performed by the master BMS or the controller 100.

The examples of the present disclosure described above may be implemented as computer readable code on a medium on which a program is recorded. The computer readable medium includes all kinds of recording devices capable of storing data readable by a computer system. Examples of computer-readable media include hard disk drives (HDDs), solid state disks (SSDs), silicon disk drives (SDDs), ROMs, RAMs, CD-ROMs, magnetic tapes, floppy disks, and optical data storage devices, and may also include media implemented in the form of a carrier wave (e.g., transmission on the Internet). Therefore, the foregoing detailed description is to be construed in all aspects as illustrative and not restrictive. The scope of the present disclosure should be determined by the reasonable interpretation of the appended claims, and all changes within the equivalents of this disclosure are included within the scope of the present disclosure.

1. A multi-battery, comprising:
a plurality of battery packs, each comprising at least one battery cell and a battery managing system (BMS) configured to manage the at least one battery cell,
wherein, based on that a power-on signal for turning on power is received, a master BMS of a master battery pack of the plurality of battery packs detects, among at least one slave battery pack of the plurality of battery packs, a first slave battery pack that is not powered on,
wherein, based on detecting that the first slave battery pack is not powered on, the master BMS transmits a preset power-on signal to a BMS of the first slave battery pack to power the first slave battery pack on, and
wherein the plurality of battery packs is indicated to be powered on only when all of the at least one slave battery pack and the master battery pack are powered on.

2. The multi-battery of claim 1, wherein the BMS of the master battery pack is configured to:
based on that a power-off signal for turning off the power is received, detect, among the at least one slave battery pack, a second slave battery pack that is not powered off;
based on detecting that the second slave battery pack is not powered off, transmit a preset power-off signal to a BMS of the second slave battery pack to power the second slave battery pack off; and
power off the master battery pack after all of the at least one slave battery pack is powered off.

3. The multi-battery of claim 1, wherein the master BMS of the master battery pack is configured to:
detect an operation state of each of the plurality of battery packs including the master battery pack and the at least one slave battery pack; and
control the BMS of at least one battery pack of the plurality of battery packs according to the operation state detected to change a charging amount or a discharging amount of the at least one battery pack to keep voltages of the plurality of battery packs equal.

4. The multi-battery of claim 3, wherein, based on that at least one battery pack of the plurality of battery packs is switched to a protection mode, causing a charging or discharging to be stopped, the master BMS controls a BMS of at least one other battery pack of the plurality of battery packs not switched to the protection mode to restrict the charging or discharging of the at least one other battery pack.

5. The multi-battery of claim 4, wherein, based on whether the at least one battery pack switched to the protection mode has been switched to a normal mode, the master BMS releases a restriction on the charging or discharging of the at least one other battery pack to allow all of the plurality of battery packs to perform the charging or discharging simultaneously.

6. The multi-battery of claim 4, wherein, based on the master battery pack being switched to the protection mode, one of the at least one slave battery pack is switched to a master battery pack, and the master battery pack switched to the protection mode is switched to a slave battery pack.

7. The multi-battery of claim 3, wherein, based on that the plurality of battery packs is discharging, the master BMS detects a voltage of each of the plurality of battery packs, and detects a first battery pack of the plurality of battery packs having a higher voltage than at least one other battery pack of the plurality of battery packs, and
wherein the master BMS restricts discharging of the at least one other battery pack except the first battery pack to allow only the first battery pack to perform the discharging until the higher voltage of the first battery pack reaches the voltage of the at least one other battery pack.

8. The multi-battery of claim 3, wherein the master BMS is further configured to:
based on that the plurality of battery packs is being charged, detect a voltage of each of the plurality of battery packs, and detect a second battery pack of the plurality of battery packs having a lower voltage than at least one other battery pack of the plurality of battery packs; and
restrict charging of other battery packs of the plurality of battery packs except for the second battery pack until the lower voltage of the second battery pack reaches the voltage of the at least one other battery pack.

9. The multi-battery of claim 3, wherein the master BMS is further configured to:
detect a temperature of each of the plurality of battery packs, detect a high-temperature battery pack of the plurality of battery packs having a higher temperature than at least one other battery pack of the plurality of battery packs or a low-temperature battery pack of the plurality of battery packs having a lower temperature than a temperature of at least one other battery pack of the plurality of battery packs; and
control, based on a difference between the higher temperature of the high-temperature battery pack or the lower temperature of the low-temperature battery pack and the temperature of the at least one other battery pack, a BMS of the high-temperature battery pack to reduce a charging current or a discharging current or control a BMS of the low-temperature battery pack to increase the charging current or the discharging current, respectively.

10. The multi-battery of claim 3, wherein each of the plurality of battery packs further comprises:
a plurality of battery cells;
a first charging path allowing a charging current supplied by a device equipped with the multi-battery to flow therethrough;
a second charging path connected in parallel with the plurality of battery cells and arranged to supply the charging current from the first charging path to the plurality of battery cells;
a charging Field Effect Transistor (FET) disposed between the first charging path and the second charging path and configured to connect or disconnect the first charging path and the second charging path depending on an charging gate driving voltage applied;
a second discharging path connected in parallel with the plurality of battery cells and allowing a discharging current discharged from the plurality of battery cells to flow therethrough;
a first discharging path arranged to supply the discharging current from the second discharging path to the device equipped with the multi-battery; and
a discharging FET disposed between the first discharging path and the second discharging path and configured to connect or disconnect the first discharging path and the second discharging path depending on an discharging gate driving voltage applied,
wherein the master BMS is configured to apply the charging gate driving voltage and the discharging gate driving voltage to the charging FET and the discharging FET, respectively.

11. The multi-battery of claim 10, wherein, based on the charging gate driving voltage and the discharging gate driving voltage being greater than or equal to a preset threshold voltage, the charging FET and the discharging FET vary an amount of current allowed to flow between the first charging path and the second charging path or between the first discharging path and the second discharging path according to magnitudes of the voltages, and
wherein the master BMS controls the charging gate driving voltage and the discharging gate driving voltage applied to the charging FET and the discharging FET to control the charging amount or the discharging amount of the plurality of battery packs.

12. The multi-battery of claim 10, further comprising:
at least one variable resistor having a varying resistance controlled by the master BMS, the at least one variable resistor disposed between at least one of the first charging path or the second charging path and the charging FET, and between at least one of the first discharging path or the second discharging path and the discharging FET, and
wherein the master BMS controls the at least one variable resistor to limit an amount of current between the first charging path and the second charging path or between the first discharging path and the second discharging path to vary the charging amount or the discharging amount of the plurality of battery packs.

13. A method of controlling a multi-battery including a plurality of battery packs each comprising at least one battery cell and a Battery Managing System (BMS) configured to manage the at least one battery cell, the method comprising:
controlling, by a master BMS of a master battery pack of the plurality of battery packs, the plurality of battery packs, including the master battery pack and at least one other slave battery pack, according to a power-on signal to cause all of the plurality of battery packs to perform charging or discharging simultaneously;
collecting, by the master BMS pack, operation state related information of the plurality of battery packs, the operation state related information comprising at least one of a temperature, a voltage, or a state of switching to a protection mode of the plurality of battery packs;
detecting, by the master BMS, some battery packs switched to the protection mode among the plurality of battery packs based on the operation state related information collected;
restricting, by the master BMS, the charging or the discharging of other battery packs of the plurality of battery packs except for the some battery packs switched to the protection mode;
determining, by the master BMS, whether the some battery packs switched to the protection mode have been switched to a normal mode; and
releasing, by the master BMS, a restriction on the charging or the discharging of the other battery packs according to a result of the determining, and controlling the plurality of battery packs to cause all the other battery packs and the some battery packs switched to the normal mode to perform the charging or the discharging simultaneously.

14. The method of claim 13, wherein the collecting of the operation state related information comprises:
detecting, by the master BMS, the voltage of each of the plurality of battery packs;
detecting, by the master BMS, a first battery pack having a higher voltage than at least one other battery pack or a second battery pack having a lower voltage than at least one other battery pack; and
based on whether the plurality of battery packs is performing the discharging or the charging, restricting, by the master BMS, the discharging of the at least one other battery pack except for the first battery pack to allow the first battery pack to perform the discharging, or restricting the charging of the at least one other battery pack except for the second battery pack to allow the second battery pack to perform the charging.

15. A robot equipped with the multi-battery of claim 1, the robot comprising:
a battery unit comprising the multi-battery;
a switch configured to receive an input signal for powering on or off the battery unit;
an indicator configured to indicate a power-on state or a power-off state of the battery unit according to the input signal; and
a controller configured to:
transmit, based on that the power-on signal being input through the switch while the battery unit is powered off, the power-on signal to each of the plurality of battery packs of the battery unit to power on each of the plurality of battery packs of the battery unit; and
control, based on that the at least one slave battery pack and the master battery pack are all powered on, the indicator to indicate the power-on state of the plurality of battery packs.

16. The robot of claim 15, wherein, based on that the master battery pack is not powered on by a transmission of the power-on signal, the controller switches one battery pack of the at least one slave battery pack to a master battery pack and switches the master battery pack not powered on to a slave battery pack, and
wherein a BMS of the one battery pack switched to the master battery pack according to the control by the controller is configured to:
detect a power of at least one slave battery pack not powered on by the power-on signal; and
turn on the power of the at least one slave battery pack detected.

17. The robot of claim 15, wherein the controller is configured to:
transmit, based on that a power-off signal is input through the switch while the battery unit is powered on, the power-off signal to each of the plurality of battery packs of the battery unit to power off each of the plurality of battery packs of the battery unit; and
control, based on that the at least one slave battery pack and the master battery pack are all powered off, the indicator to indicate that the plurality of battery packs is powered off.

18. The robot of claim 15, wherein, based on that at least one battery pack among the plurality of battery packs exceeds a preset operating temperature range, the controller switches the at least one battery pack to a protection mode,
wherein the controller controls a BMS of at least one other battery pack of the plurality of battery packs not switched to the protection mode to restrict charging or discharging of the at least one other battery pack, and
wherein the controller releases a restriction on the charging or the discharging of the at least one other battery pack based on whether the at least one battery pack switched to the protection mode has been switched to a normal mode to control the battery unit to cause all of the plurality of battery packs to perform the charging or the discharging simultaneously.

19. The robot of claim 18, wherein, based on that the plurality of battery packs is discharging, the controller detects a voltage of each of the plurality of battery packs, and detects a first battery pack having a lowest voltage of the plurality of battery packs, and
wherein the controller restricts the discharging of the first battery pack until voltages of other battery packs of the plurality of battery packs except for the first battery pack reach the lowest voltage of the first battery pack.

20. The robot of claim 18, wherein, based on that the plurality of battery packs is charging, the controller detects a voltage of each of the plurality of battery packs, and detects a second battery pack having a highest voltage of the plurality of battery packs, and
wherein the controller restricts charging of the second battery pack until voltages of the other battery packs of the plurality of battery packs except for the second battery pack reach the highest voltage of the second battery pack.
